(19) United States
(12) Patent Application Publication
(10) Pub. No.: US 2026/0281753 A1
(43) Pub. Date: Sep. 17, 2026

(54) ARTIFICIAL INTELLIGENCE-BASED NETWORK PERFORMANCE PREDICTION TRAINING

(71) Applicant: QUALCOMM Incorporated, San Diego, CA (US)

(72) Inventors: Srinivas YERRAMALLI, San Diego, CA (US); Rajat PRAKASH, San Diego, CA (US); Yitao CHEN, San Marcos, CA (US); Arumugam CHENDAMARAI KANNAN, San Diego, CA (US)

(21) Appl. No.: 19/077,614

(22) Filed: Mar. 12, 2025

(51) Int. Cl. H04W 24/06; G06N 3/042; G06N 3/09

(52) U.S. Cl. CPC H04W 24/06; G06N 3/042; G06N 3/09

(57) ABSTRACT

Certain aspects of the present disclosure provide techniques for training an artificial intelligence-based wireless communication network simulator. An example method includes obtaining first training data associated with a first network simulator, wherein the first training data includes first parameters associated with simulation of a wireless network operating, in a scenario, according to first configurations, wherein the wireless network includes a network node in communication with a user equipment (UE); obtaining second training data associated with a second network simulator, wherein the second training data includes second parameters associated with simulation of the wireless network operating, in the scenario, according to second configurations; generating third training data based at least in part on the first training data and the second training data; and training a machine learning model, associated with prediction of performance metrics of the wireless network, based at least in part on the third training data.

### INTRODUCTION

### Field of the Disclosure

Aspects of the present disclosure relate to wireless communications, and more particularly, to techniques for wireless communication network performance prediction.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method for wireless communications by an apparatus. The method includes obtaining a first training data set associated with a first network simulator, wherein the first training data set includes a first plurality of parameters associated with simulation of a wireless communication network operating, in a scenario, according to a first plurality of configurations, wherein the wireless communication network includes at least one network node in communication with at least one user equipment (UE); obtaining a second training data set associated with a second network simulator, wherein the second training data set includes a second plurality of parameters associated with simulation of the wireless communication network operating, in the scenario, according to a second plurality of configurations; generating a third training data set based at least in part on the first training data set and the second training data set; and training one or more machine learning models, associated with prediction of one or more performance metrics of the wireless communication network, based at least in part on the third training data set.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 depicts an example artificial intelligence (AI) architecture that may be used for AI-enhanced wireless communications.

FIG. 6 depicts an example artificial neural network.

FIG. 7 depicts an example scheme for using an AI-based network simulator to predict the performance of a wireless communication network.

FIG. 8 depicts an example architecture of an AI-based network key performance indicator predictor.

FIG. 9 depicts an example graph data structure of a training data set associated with a wireless communication network.

FIG. 10 depicts an example multi-simulator training architecture.

FIG. 11 depicts another example multi-simulator training architecture.

FIG. 12 depicts another example multi-simulator training architecture.

FIG. 13A depicts a process flow for communication of signaling related to training an AI-based network simulator.

FIG. 13B depicts another process flow for communication of signaling related to training an AI-based network simulator.

FIG. 14 depicts another process flow for communication of signaling related to training an AI-based network simulator.

FIG. 15 depicts an example architecture for training a machine learning model for network performance simulation.

FIG. 16 depicts a method for wireless communications.

FIG. 17 depicts aspects of an example communications device.

### DETAILED DESCRIPTION

Aspects of the present disclosure provide apparatuses, methods, processing systems, and computer-readable mediums for techniques for training an artificial intelligence-based wireless communication network simulator.

Wireless communication networks (e.g., 5G New Radio (NR) systems and/or any other suitable or future wireless communication system) use several network nodes (e.g., base stations and/or disaggregated entities thereof, as further described herein) to facilitate wireless services with high data rates, low latencies, and/or high reliability for a large number of user equipment (UEs). In order to accommodate a specific deployment scenario (e.g., indoor, outdoor, topography, buildings, trees, etc.) of a service area, the network nodes may provide coverage areas of various sizes (for example, macro cells, micro cells, pico cells, femto cells, etc.) and be deployed across various locations and elevations of the service area. The service area may refer to the overall coverage area facilitated by a plurality of network nodes of a wireless communication network, such as a tracking area and/or the overall coverage area of a public land mobility network. As used herein, a wireless communication network may be or include a plurality of network nodes operating to provide a service area formed from a plurality of coverage areas associated with the network nodes. In certain cases, the wireless communication network may correspond to one or more tracking areas, one or more public land mobility networks, and/or a portion thereof. In certain cases, the wireless communication network may enable communication of various types of user traffic (such as asymmetric uplink-downlink traffic, gaming traffic, extended reality (XR) traffic, vehicle-to-everything (V2X) traffic, Internet-of-Things (IoT) traffic, and/or the like) having a range of quality-of-service (QoS) specifications, for example, in terms of latency, throughput, and/or reliability specifications.

Technical problems for wireless communication networks may include, for example, forming effective performance predictions of a wireless communication network, for example, in association with development, deployment, operation, and/or management of various devices operating in the service area or to facilitate the service area. In certain cases, various entities (such as network vendors, UE vendors, and/or network operators) may use a network simulator to simulate the behavior of a wireless communication network. The network simulator may provide predictions on the performance of the wireless communication network operating under various traffic loads and/or configurations. A network vendor may refer to an entity that designs or supplies equipment or hardware that facilitates the use of a wireless communication network, such as radio heads, base stations, servers, routers, switches, software, and/or the like. A UE vendor may refer to an entity that designs or supplies equipment or hardware that facilitates the use of a UE, such as smartphones, wearable devices, cellular phones, XR headsets, vehicles, IoT devices, and/or the like.

As an example, in association with developing a deployment plan for a wireless communication network (such as a Sixth Generation (6G) system), a network vendor may run simulations to determine the performance of the deployment plan, for example, in terms of expected latencies, throughputs, and/or reliability (e.g., error rates) at various locations across the service area of the wireless communication network. The deployment plan may provide the location of network nodes, the location and size of coverage areas, the traffic capacity of network nodes, and/or the like. The simulations may enable the network vendor to determine whether the deployment plan can meet certain performance specifications of a network operator (e.g., latencies, throughput, reliability, power consumption, channel usage, and/or the like).

As another example, in association with designing and/or developing portable wireless communication devices (such as smartphones or wearable devices), a UE vendor may perform network simulations to evaluate the performance of various types of UEs (e.g., smartphones, wearable devices, XR headsets, vehicles, IoT devices, and/or the like) operating under various traffic loads in the wireless communication network. The simulations may enable the UE vendor to determine whether the UE designs can meet certain performance specifications (e.g., latencies, throughput, reliability, power consumption, and/or the like), for example, expected by end users of the UEs.

In certain cases, the network simulator may be or include a Monte-Carlo-based simulator to predict the performance of a wireless communication network. A Monte-Carlo-based simulator may refer to a simulator that uses Monte-Carlo prediction techniques to determine the performance of a wireless communication network. In certain aspects, for Monte-Carlo-based simulations, the network simulator sweeps, for each parameter among a plurality of parameters, a range of parameter values associated with a digital model of a wireless communication network (e.g., sometimes referred to as a radio digital twin or a network digital twin). A radio digital twin may refer to a set of digital models that emulate or simulate the behavior of a wireless communication device, such as a network node and/or UE, in a virtual system. A network digital twin may refer to a set of digital models that emulate or simulate the behavior of a wireless communication network in a virtual system. As an example, the parameters may include network node traffic loads, UE traffic loads, error rates, traffic profiles (such as a distribution of asymmetric traffic, gaming traffic, XR traffic, etc.), UE trajectories, and/or the like. Thus, the processing latency and processing resource usage (e.g., processor and/or memory usage) of the network simulation may depend on the number of parameters and corresponding range of values configured for the digital model of the wireless communication network.

In certain cases, Monte-Carlo simulations may be re-done, for example, if there are any changes to the network configuration, such as the addition of network node to the service area and/or there being sufficient changes in the UE traffic profile. Moreover, the performance predictions of a wireless communication network may not be applicable to another wireless communication network due to the differing configurations and/or model parameters used in the digital models. In other words, Monte-Carlo simulations may be performed for multiple service areas (e.g., airports, stadiums, cities, highways, train routes, etc.) associated with several wireless communication networks. Thus, the Monte-Carlo-based network simulator may use a non-trivial amount of time and processing resources to generate performance predictions, which can affect the cost of performing network simulations. In certain cases, it may take a non-trivial amount of time and effort to adapt a configuration of a Monte-Carlo simulator to match logs and/or field data encountered by a real wireless communication network, for example, due to the number of parameters and corresponding range of values configured for the digital model of the wireless communication network.

In certain cases, an AI-based network simulator may be used to determine performance predictions associated with a wireless communication network. An AI-based network simulator may refer to a network simulator that includes one or more AI models and/or one or more machine learning (ML) models configured or trained to generate performance predictions associated with a wireless communication network, as further described herein. The AI-based network simulator may include one or more AI models or one or more ML models configured to take input data (e.g., operating parameters of a wireless communication network), and output one or more performance predictions associated with the wireless communication network, and therefore, the AI-based network simulator provides a simulation as to the operations of a wireless communication network. In order to train the AI models to make predictions at a threshold level of accuracy, AI-based network simulators may rely on training data representative of the expected performance of wireless communication networks in various operating scenarios and/or configurations.

A network simulator may use certain algorithms to model the behaviors of various devices in the wireless communication network, such as network nodes and UEs. In certain cases, one entity (e.g., a network vendor) may use different algorithms than another entity (e.g., a UE vendor) to simulate the behavior of certain devices, such as a UE and a network node. Due to security issues, certain entities (e.g., network vendors and/or UE vendors) may be reluctant to share certain information with each other related to the algorithms used to model the behaviors of devices in the wireless communication network, for example, in order to prevent or mitigate competitors from learning secure information related to device implementations and/or techniques. Accordingly, the accuracy of AI-based network simulators may be affected by the level of information shared among different wireless communication entities in association with training AI-models.

Aspects described herein may overcome the aforementioned technical problem(s), for example, by providing certain scheme(s) for training an AI-based wireless communication network simulator (hereinafter “the AI-based network simulator”), which may enable effective determination of performance predictions, for example, in terms of processing latency, model or digital twin adaptability, and/or the like. In certain aspects, a training scheme may include obtaining training data sets derived from different network simulators, such as a network simulator operated by a UE vendor and another network simulator operated by a network vendor. The training data sets may enable an entity to train an AI model to predict the performance of the wireless communication network. In certain cases, the training data sets may be combined into a joint or common training data set. In certain cases, the AI model may include a graph neural network, and the training data set may be in the form of a graph data structure.

In certain cases, the network simulators may generate training data sets that include performance predictions of the wireless communication network operating in a scenario according to various configurations, such as a range of network node traffic loads, UE traffic loads, error rates, UE traffic profiles, etc. In certain cases, the scenario associated with the simulations may define certain static or common properties used by the network simulators in simulating the operations or behaviors of the wireless communication network, such as according to one or more different configurations. In certain cases, a configuration may define one or more dynamic or device-specific properties used by the network simulators in simulating the operations or behaviors of the wireless communication network. As an example, the scenario may define a total number of UEs in a service area, a total number of network nodes in the service area, network node locations, UE locations and/or UE trajectories, coverage areas of network nodes, topology, physical environment models (e.g., buildings, trees, roads, indoor models, outdoor models, etc.), and/or the like. In certain cases, certain information (for example, some of the configurations applied by the network simulators) may be shared among the network simulators in order to generate the training data sets. In certain cases, the shared information may include simulated UE-network node traffic, as further described herein.

Certain techniques for training an AI-based network simulator described herein may provide various beneficial technical effects and/or advantages. The techniques for training an AI-based network simulator may enable improved wireless communication performance, such as reduced latencies, increased throughput, effective channel usage, reduced power consumption, and/or the like. As an example, the trained AI-based network simulator may enable determination of various network configurations (e.g., beam shape, beam orientation, transmit power, protocol stack behaviors, and/or the like) that satisfy certain performance specifications (e.g., latencies, throughput, channel usage, power consumption, and/or the like).

In certain cases, the techniques for training an AI-based network simulator may enable improved performance of network simulators, for example, in terms of simulator adaptability (for example, to field data and/or network model reconfigurations), reduced processing latencies, and/or the like. As an example, the AI-based network simulator may be trained using field data and/or field logs to allow the AI-based network simulator to effectively take into account or consider field data and/or field logs in forming performance predictions. In certain cases, the AI-based network simulator may be trained using various network model configurations, which may enable the AI-based network simulator to effectively be familiar with the performance of various network configurations. Thus, when there is a reconfiguration to a network model, the AI-based network simulator may be trained to generate a performance prediction for such configuration, which may avoid running a full sweep of Monte-Carlo simulations. In certain cases, the AI-based network simulator may be able to generate performance predictions with a reduced processing latency compared to Monte-Carlo simulators.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

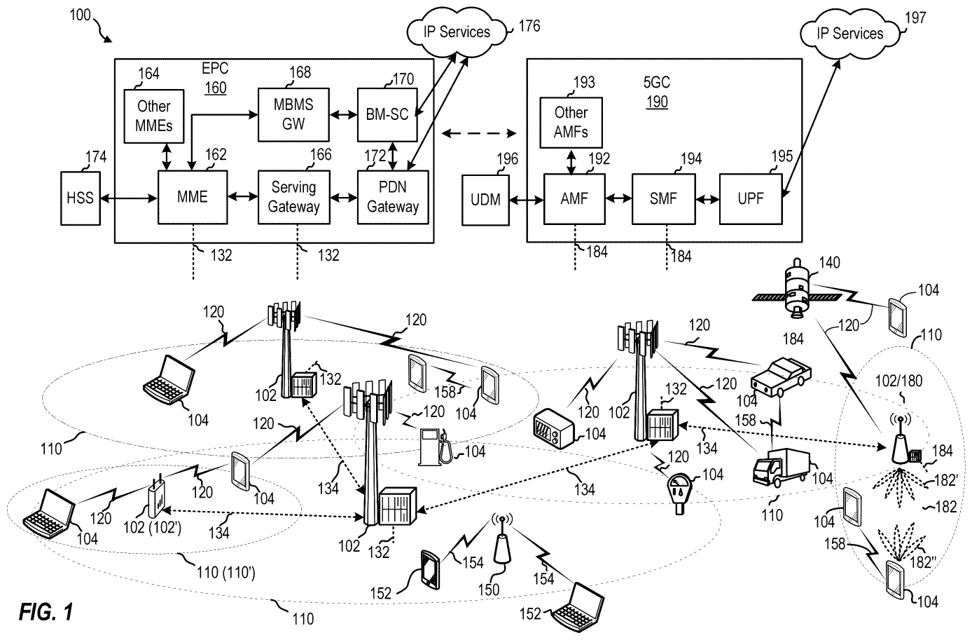

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

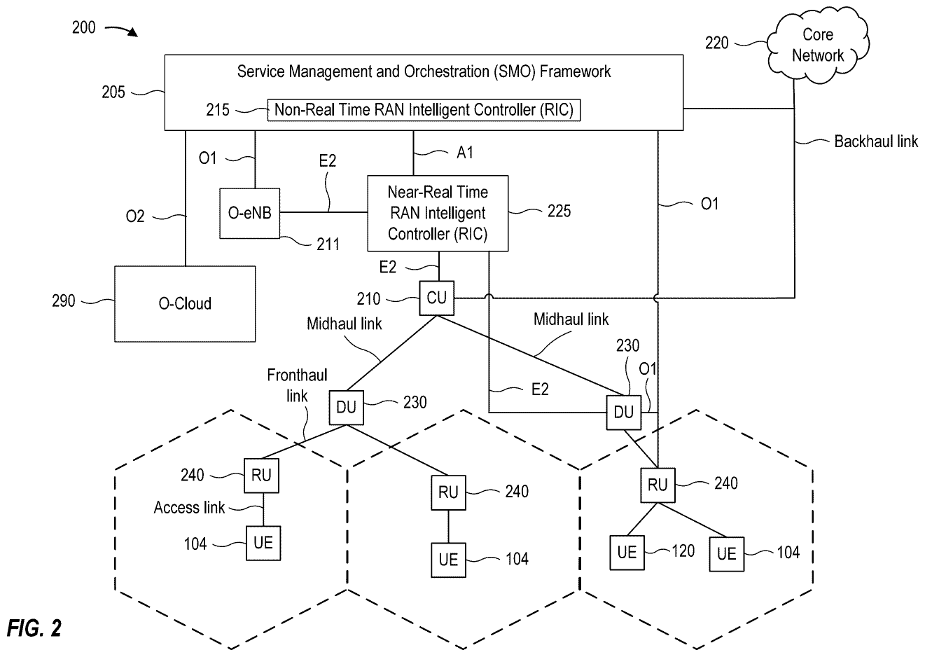

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

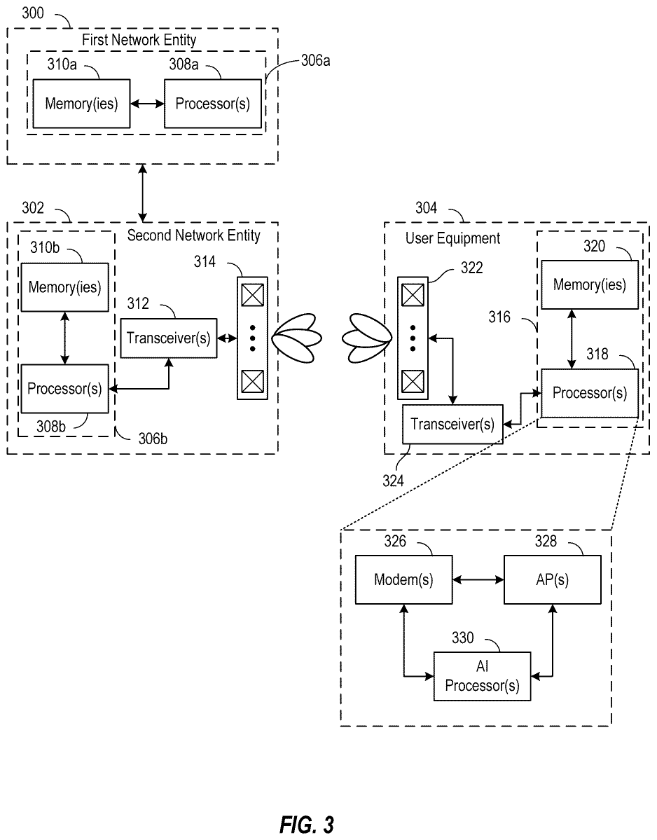

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In s ome examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

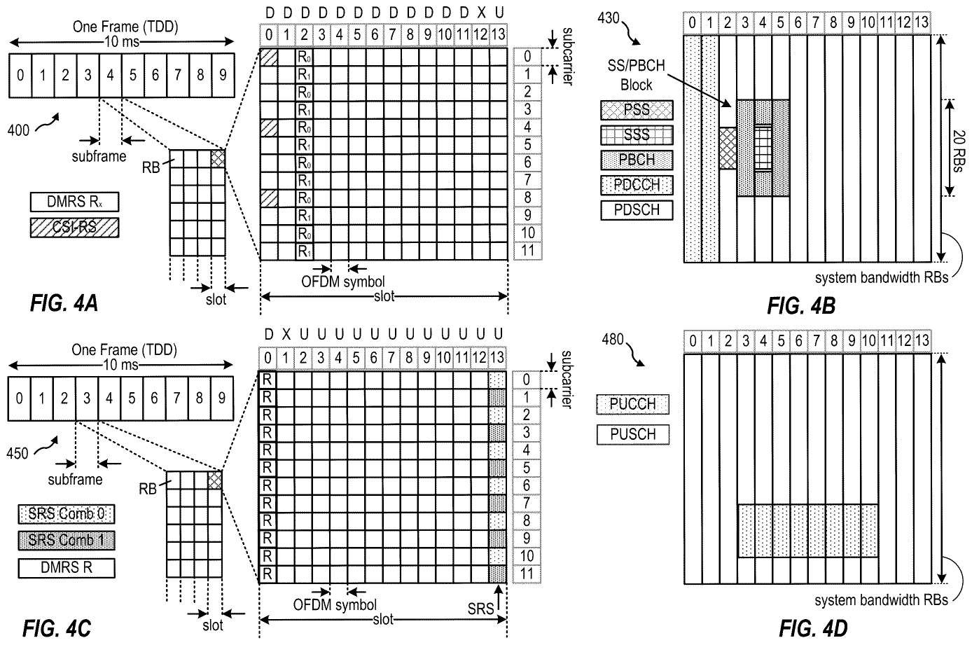

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 2^{μ} slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Artificial Intelligence for Wireless Communications

Certain aspects described herein may be implemented, at least in part, using some form of artificial intelligence (AI), e.g., the process of using a machine learning (ML) model to infer or predict output data based on input data. An example ML model may include a mathematical representation of one or more relationships among various objects to provide an output representing one or more predictions or inferences. Once an ML model has been trained, the ML model may be deployed to process data that may be similar to, or associated with, all or part of the training data and provide an output representing one or more predictions or inferences based on the input data.

ML is often characterized in terms of types of learning that generate specific types of learned models that perform specific types of tasks. For example, different types of machine learning include supervised learning, unsupervised learning, semi-supervised learning, and reinforcement learning.

Supervised learning algorithms generally model relationships and dependencies between input features (e.g., a feature vector) and one or more target outputs. Supervised learning uses labeled training data, which are data including one or more inputs and a desired output. Supervised learning may be used to train models to perform tasks like classification, where the goal is to predict discrete values, or regression, where the goal is to predict continuous values. Some example supervised learning algorithms include nearest neighbor, naive Bayes, decision trees, linear regression, support vector machines (SVMs), and artificial neural networks (ANNs).

Unsupervised learning algorithms work on unlabeled input data and train models that take an input and transform it into an output to solve a practical problem. Examples of unsupervised learning tasks are clustering, where the output of the model may be a cluster identification, dimensionality reduction, where the output of the model is an output feature vector that has fewer features than the input feature vector, and outlier detection, where the output of the model is a value indicating how the input is different from a typical example in the dataset. An example unsupervised learning algorithm is k-Means.

Semi-supervised learning algorithms work on datasets containing both labeled and unlabeled examples, where often the quantity of unlabeled examples is much higher than the number of labeled examples. However, the goal of a semi-supervised learning is that of supervised learning. Often, a semi-supervised model includes a model trained to produce pseudo-labels for unlabeled data that is then combined with the labeled data to train a second classifier that leverages the higher quantity of overall training data to improve task performance.

Reinforcement learning algorithms use observations gathered by an agent from an interaction with an environment to take actions that may maximize a reward or minimize a risk. Reinforcement learning is a continuous and iterative process in which the agent learns from its experiences with the environment until it explores, for example, a full range of possible states. An example type of reinforcement learning algorithm is an adversarial network. Reinforcement learning may be particularly beneficial when used to improve or attempt to optimize a behavior of a model deployed in a dynamically changing environment, such as a wireless communication network.

ML models may be deployed in one or more devices (e.g., network entities such as base station(s) and/or user equipment(s)) to support various wired and/or wireless communication aspects of a communication system. For example, an ML model may be trained to identify patterns and relationships in data corresponding to a network, a device, an air interface, or the like. An ML model may improve operations relating to one or more aspects, such as network performance prediction, transceiver circuitry controls, frequency synchronization, timing synchronization, channel state estimation, channel equalization, channel state feedback, modulation, demodulation, device positioning, transceiver tuning, beamforming, signal coding/decoding, network routing, load balancing, and energy conservation (to name just a few) associated with communications devices, services, and/or networks. AI-enhanced transceiver circuitry controls may include, for example, filter tuning, transmit power controls, gain controls (including automatic gain controls), phase controls, power management, and the like.

Aspects described herein may describe the performance of certain tasks and the technical solution of various technical problems by application of a specific type of ML model, such as an ANN including, for example, a graph neural network (GNN), as further described herein. It should be understood, however, that other type(s) of AI models may be used in addition to or instead of an ANN. An ML model may be an example of an AI model, and any suitable AI model may be used in addition to or instead of any of the ML models described herein. Hence, unless expressly recited, subject matter regarding an ML model is not necessarily intended to be limited to just an ANN solution or machine learning. Further, it should be understood that, unless otherwise specifically stated, terms such “AI model,” “ML model,” “AI/ML model,” “trained ML model,” and the like are intended to be interchangeable.

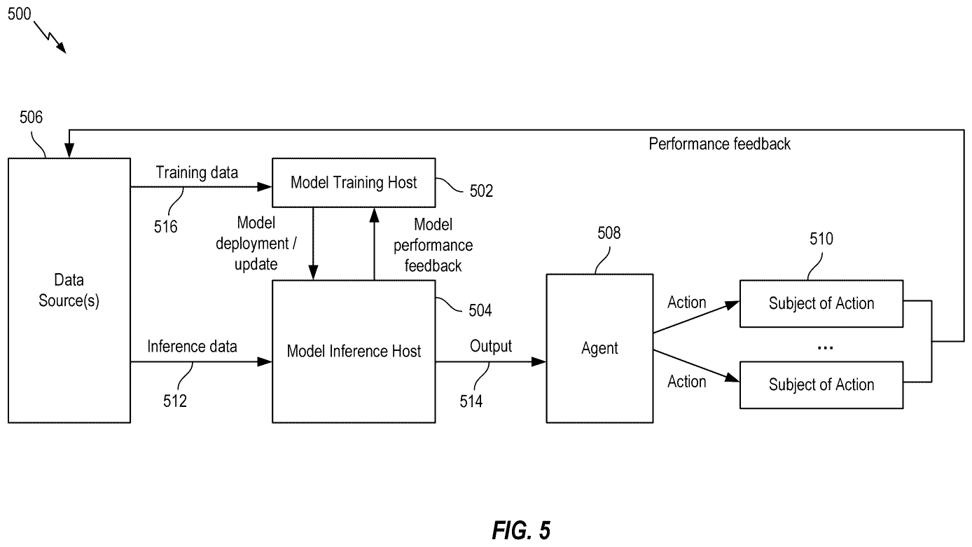

FIG. 5 is a diagram illustrating an example AI architecture 500 that may be used for AI-enhanced wireless communications. As illustrated, the architecture 500 includes multiple logical entities, such as a model training host 502, a model inference host 504, data source(s) 506, and an agent 508. The AI architecture may be used in any of various use cases for wireless communications, such as described herein.

The model inference host 504, in the architecture 500, is configured to run an ML model based on inference data 512 provided by data source(s) 506. The model inference host 504 may produce an output 514 (e.g., a prediction or inference, such as a discrete or continuous value) based on the inference data 512, that is then provided as input to the agent 508. In certain aspects, the model inference host 504 may be an example of a model inference agent.

The agent 508 may be an element or an entity of a wireless communication system including, for example, a radio access network (RAN), a wireless local area network, a device-to-device (D2D) communications system, etc. In certain examples, the agent 508 may be an example of a decision agent. In some examples, the agent 508 may be a UE, a base station, or any disaggregated entity thereof including a CU, a DU, and/or an RU, an access point, a wireless station, a RIC in a cloud-based RAN, among some examples. Additionally, the type of agent 508 may also depend on the type of tasks performed by the model inference host 504, the type of inference data 512 provided to model inference host 504, and/or the type of output 514 produced by model inference host 504.

For example, if output 514 from the model inference host 504 is associated with network performance prediction, the agent 508 may be or include a UE, a DU, or an RU. As another example, if output 514 from model inference host 504 is associated with transmission and/or reception scheduling (in association network performance prediction), the agent 508 may be a CU or a DU.

After the agent 508 receives output 514 from the model inference host 504, agent 508 may determine whether to act based on the output. For example, if agent 508 is a DU or an RU and the output from model inference host 504 is associated with beam management (in association with a network performance prediction), the agent 508 may determine whether to change or modify a transmit and/or receive beam based on the output 514. If the agent 508 determines to act based on the output 514, agent 508 may indicate the action to at least one subject of the action 510. For example, if the agent 508 determines to change or modify a transmit and/or receive beam for a communication between the agent 508 and the subject of action 510 (e.g., a UE), the agent 508 may send a beam switching indication to the subject of action 510 (e.g., a UE).

As another example, the agent 508 may be a UE, the output 514 from model inference host 504 may be a set of serving cells available for communication along a UE trajectory (in association with a network performance prediction). For example, the model inference host 504 may predict the candidate cells based on the UE trajectory in the service area of a wireless communication network. Based on the predicted serving cell, the agent 508, such as the UE, may send, to the subject of action 510, such as a BS, a request(s) to establish communications with the serving cells along the UE trajectory. In some cases, the agent 508 and the subject of action 510 are the same entity.

The data sources 506 may be configured for collecting data that is used as training data 516 for training an ML model, or as inference data 512 for feeding an ML model inference operation. In particular, the data sources 506 may collect data from any of various entities (e.g., the UE and/or the BS), which may include the subject of action 510, and provide the collected data to a model training host 502 for ML model training.

For example, after a subject of action 510 (e.g., a UE) receives a beam configuration from agent 508, the subject of action 510 may provide performance feedback associated with the beam configuration to the data sources 506, where the performance feedback may be used by the model training host 502 for monitoring and/or evaluating the ML model performance, such as whether the output 514, provided to agent 508, is accurate. In some examples, if the output 514 provided to agent 508 is inaccurate (or the accuracy is below an accuracy threshold), the model training host 502 may determine to modify or retrain the ML model used by model inference host 504, such as via an ML model deployment/update.

In certain aspects, the model training host 502 may be deployed at or with the same or a different entity than that in which the model inference host 504 is deployed. For example, in order to offload model training processing, which can impact the performance of the model inference host 504, the model training host 502 may be deployed at a model server. Further, in some cases, training and/or inference may be distributed amongst devices in a decentralized or federated fashion.

In some aspects, an ML model is deployed at or on a network entity for network performance prediction. More specifically, a model inference host, such as model inference host 504 in FIG. 5, may be deployed at or on the network entity for simulation of the performance associated with a wireless communication network.

In some aspects, an ML model is deployed at or on a UE for network performance prediction. More specifically, a model inference host, such as model inference host 504 in FIG. 5, may be deployed at or on the UE for simulation of the performance associated with a wireless communication network.

In some aspects, an ML model is deployed at or on a computational device for network performance prediction. More specifically, a model inference host, such as model inference host 504 in FIG. 5, may be deployed at or on a server (e.g., a virtual server) for simulation of the performance associated with a wireless communication network.

### Example Artificial Intelligence Model

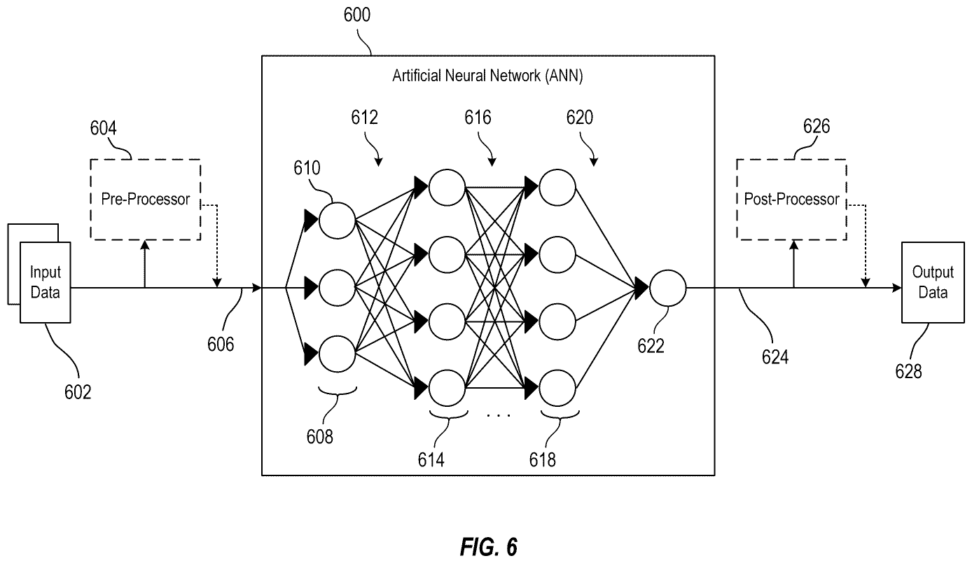

FIG. 6 is an illustrative block diagram of an example artificial neural network (ANN) 600.

ANN 600 may receive input data 606 which may include one or more bits of data 602, pre-processed data output from pre-processor 604 (optional), or some combination thereof. Here, data 602 may include training data, verification data, application-related data, or the like, e.g., depending on the stage of development and/or deployment of ANN 600. Pre-processor 604 may be included within ANN 600 in some other implementations. Pre-processor 604 may, for example, process all or a portion of data 602 which may result in some of data 602 being changed, replaced, deleted, etc. In some implementations, pre-processor 604 may add additional data to data 602.

ANN 600 includes at least one first layer 608 of artificial neurons 610 (e.g., perceptrons) to process input data 606 and provide resulting first layer output data via edges 612 to at least a portion of at least one second layer 614. Second layer 614 processes data received via edges 612 and provides second layer output data via edges 616 to at least a portion of at least one third layer 618. Third layer 618 processes data received via edges 616 and provides third layer output data via edges 620 to at least a portion of a final layer 622 including one or more neurons to provide output data 624. All or part of output data 624 may be further processed in some manner by (optional) post-processor 626. Thus, in certain examples, ANN 600 may provide output data 628 that is based on output data 624, post-processed data output from post-processor 626, or some combination thereof. Post-processor 626 may be included within ANN 600 in some other implementations. Post-processor 626 may, for example, process all or a portion of output data 624 which may result in output data 628 being different, at least in part, to output data 624, e.g., as result of data being changed, replaced, deleted, etc. In some implementations, post-processor 626 may be configured to add additional data to output data 624. In this example, second layer 614 and third layer 618 represent intermediate or hidden layers that may be arranged in a hierarchical or other like structure. Although not explicitly shown, there may be one or more further intermediate layers between the second layer 614 and the third layer 618.

The structure and training of artificial neurons 610 in the various layers may be tailored to specific requirements of an application. Within a given layer of an ANN, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” artificial neurons of a next layer. Artificial neurons in such a layer may be activated by or be responsive to weights and biases that may be adjusted during a training process. Weights of the various artificial neurons may act as parameters to control a strength of connections between layers or artificial neurons, while biases may act as parameters to control a direction of connections between the layers or artificial neurons. An activation function may select or determine whether an artificial neuron transmits its output to the next layer or not in response to its received data. Different activation functions may be used to model different types of non-linear relationships. By introducing non-linearity into an ML model, an activation function allows the ML model to “learn” complex patterns and relationships in the input data (e.g., 506 in FIG. 5). Some non-exhaustive example activation functions include a linear function, binary step function, sigmoid, hyperbolic tangent (tanh), a rectified linear unit (ReLU) and variants, exponential linear unit (ELU), Swish, Softmax, and others.

Design tools (such as computer applications, programs, etc.) may be used to select appropriate structures for ANN 600 and a number of layers and a number of artificial neurons in each layer, as well as selecting activation functions, a loss function, training processes, etc. Once an initial model has been designed, training of the model may be conducted using training data. Training data may include one or more datasets within which ANN 600 may detect, determine, identify or ascertain patterns. Training data may represent various types of information, including written, visual, audio, environmental context, operational properties, etc. During training, parameters of artificial neurons 610 may be changed, such as to minimize or otherwise reduce a loss function or a cost function. A training process may be repeated multiple times to fine-tune ANN 600 with each iteration.

Various ANN model structures are available for consideration. For example, in a feedforward ANN structure each artificial neuron 610 in a layer receives information from the previous layer and likewise produces information for the next layer. In a convolutional ANN structure, some layers may be organized into filters that extract features from data (e.g., training data and/or input data). In a recurrent ANN structure, some layers may have connections that allow for processing of data across time, such as for processing information having a temporal structure, such as time series data forecasting.

In an autoencoder ANN structure, compact representations of data may be processed and the model trained to predict or potentially reconstruct original data from a reduced set of features. An autoencoder ANN structure may be useful for tasks related to dimensionality reduction and data compression.

A generative adversarial ANN structure may include a generator ANN and a discriminator ANN that are trained to compete with each other. Generative-adversarial networks (GANs) are ANN structures that may be useful for tasks relating to generating synthetic data or improving the performance of other models.

A transformer ANN structure makes use of attention mechanisms that may enable the model to process input sequences in a parallel and efficient manner. An attention mechanism allows the model to focus on different parts of the input sequence at different times. Attention mechanisms may be implemented using a series of layers known as attention layers to compute, calculate, determine or select weighted sums of input features based on a similarity between different elements of the input sequence. A transformer ANN structure may include a series of feedforward ANN layers that may learn non-linear relationships between the input and output sequences. The output of a transformer ANN structure may be obtained by applying a linear transformation to the output of a final attention layer. A transformer ANN structure may be of particular use for tasks that involve sequence modeling, or other like processing.

Another example type of ANN structure, is a model with one or more invertible layers. Models of this type may be inverted or “unwrapped” to reveal the input data that was used to generate the output of a layer.

Other example types of ANN model structures include fully connected neural networks (FCNNs) and long short-term memory (LSTM) networks.

ANN 600 or other ML models may be implemented in various types of processing circuits along with memory and applicable instructions therein, for example, as described herein with respect to FIG. 5. For example, general-purpose hardware circuits, such as, such as one or more central processing units (CPUs) and one or more graphics processing units (GPUs) may be employed to implement a model. One or more ML accelerators, such as tensor processing units (TPUs), embedded neural processing units (eNPUs), or other special-purpose processors, and/or field-programmable gate arrays (FPGAs), application-specific integrated circuits (ASICs), or the like also may be employed. Various programming tools are available for developing ANN models.

### Aspects of Artificial Intelligence Model Training

There are a variety of model training techniques and processes that may be used prior to, or at some point following, deployment of an ML model, such as ANN 600 of FIG. 6.

As part of a model development process, information in the form of applicable training data may be gathered or otherwise created for use in training an ML model accordingly. For example, training data may be gathered or otherwise created regarding information associated with received/transmitted signal strengths, interference, and resource usage data, as well as any other relevant data that might be useful for training a model to address one or more problems or issues in a communication system. In certain instances, all or part of the training data may originate in one or more user equipments (UEs), one or more network entities, or one or more other devices in a wireless communication system. In some cases, all or part of the training data may be aggregated from multiple sources (e.g., one or more UEs, one or more network entities, the Internet, etc.). For example, wireless network architectures, such as self-organizing networks (SONs) or mobile drive test (MDT) networks, may be adapted to support collection of data for ML model applications. In another example, training data may be generated or collected online, offline, or both online and offline by a UE, network entity, or other device(s), and all or part of such training data may be transferred or shared (in real or near-real time), such as through store and forward functions or the like. Offline training may refer to creating and using a static training dataset, e.g., in a batched manner, whereas online training may refer to a real-time or near-real-time collection and use of training data. For example, an ML model at a network device (e.g., a UE) may be trained and/or fine-tuned using online or offline training. For offline training, data collection and training can occur in an offline manner at the network side (e.g., at a base station or other network entity) or at the UE side. For online training, the training of a UE-side ML model may be performed locally at the UE or by a server device (e.g., a server hosted by a UE vendor) in a real-time or near-real-time manner based on data provided to the server device from the UE.

In certain instances, all or part of the training data may be shared within a wireless communication system, or even shared (or obtained from) outside of the wireless communication system.

Once an ML model has been trained with training data, its performance may be evaluated. In some scenarios, evaluation/verification tests may use a validation dataset, which may include data not in the training data, to compare the model's performance to baseline or other benchmark information. If model performance is deemed unsatisfactory, it may be beneficial to fine-tune the model, e.g., by changing its architecture, re-training it on the data, or using different optimization techniques, etc. Once a model's performance is deemed satisfactory, the model may be deployed accordingly. In certain instances, a model may be updated in some manner, e.g., all or part of the model may be changed or replaced, or undergo further training, just to name a few examples.

As part of a training process for an ANN, such as ANN 600 of FIG. 6, parameters affecting the functioning of the artificial neurons and layers may be adjusted. For example, backpropagation techniques may be used to train the ANN by iteratively adjusting weights and/or biases of certain artificial neurons associated with errors between a predicted output of the model and a desired output that may be known or otherwise deemed acceptable. Backpropagation may include a forward pass, a loss function, a backward pass, and a parameter update that may be performed in training iteration. The process may be repeated for a certain number of iterations for each set of training data until the weights of the artificial neurons/layers are adequately tuned.

Backpropagation techniques associated with a loss function may measure how well a model is able to predict a desired output for a given input. An optimization algorithm may be used during a training process to adjust weights and/or biases to reduce or minimize the loss function which should improve the performance of the model. There are a variety of optimization algorithms that may be used along with backpropagation techniques or other training techniques. Some initial examples include a gradient descent based optimization algorithm and a stochastic gradient descent based optimization algorithm. A stochastic gradient descent (or ascent) technique may be used to adjust weights/biases in order to minimize or otherwise reduce a loss function. A mini-batch gradient descent technique, which is a variant of gradient descent, may involve updating weights/biases using a small batch of training data rather than the entire dataset. A momentum technique may accelerate an optimization process by adding a momentum term to update or otherwise affect certain weights/biases.

An adaptive learning rate technique may adjust a learning rate of an optimization algorithm associated with one or more characteristics of the training data. A batch normalization technique may be used to normalize inputs to a model in order to stabilize a training process and potentially improve the performance of the model.

A “dropout” technique may be used to randomly drop out some of the artificial neurons from a model during a training process, e.g., in order to reduce overfitting and potentially improve the generalization of the model.

An “early stopping” technique may be used to stop an on-going training process early, such as when a performance of the model using a validation dataset starts to degrade.

Another example technique includes data augmentation to generate additional training data by applying transformations to all or part of the training information.

A transfer learning technique may be used which involves using a pre-trained model as a starting point for training a new model, which may be useful when training data is limited or when there are multiple tasks that are related to each other.

A multi-task learning technique may be used which involves training a model to perform multiple tasks simultaneously to potentially improve the performance of the model on one or more of the tasks. Hyperparameters or the like may be input and applied during a training process in certain instances.

Another example technique that may be useful with regard to an ML model is some form of a “pruning” technique. A pruning technique, which may be performed during a training process or after a model has been trained, involves the removal of unnecessary (e.g., because they have no impact on the output) or less necessary (e.g., because they have negligible impact on the output), or possibly redundant features from a model. In certain instances, a pruning technique may reduce the complexity of a model or improve efficiency of a model without undermining the intended performance of the model.

Pruning techniques may be particularly useful in the context of wireless communication, where the available resources (such as power and bandwidth) may be limited. Some example pruning techniques include a weight pruning technique, a neuron pruning technique, a layer pruning technique, a structural pruning technique, and a dynamic pruning technique. Pruning techniques may, for example, reduce the amount of data corresponding to a model that may need to be transmitted or stored.

Weight pruning techniques may involve removing some of the weights from a model. Neuron pruning techniques may involve removing some neurons from a model. Layer pruning techniques may involve removing some layers from a model. Structural pruning techniques may involve removing some connections between neurons in a model. Dynamic pruning techniques may involve adapting a pruning strategy of a model associated with one or more characteristics of the data or the environment. For example, in certain wireless communication devices, a dynamic pruning technique may more aggressively prune a model for use in a low-power or low-bandwidth environment, and less aggressively prune the model for use in a high-power or high-bandwidth environment. In certain aspects, pruning techniques also may be applied to training data, e.g., to remove outliers, etc. In some implementations, pre-processing techniques directed to all or part of a training dataset may improve model performance or promote faster convergence of a model. For example, training data may be pre-processed to change or remove unnecessary data, extraneous data, incorrect data, or otherwise identifiable data. Such pre-processed training data may, for example, lead to a reduction in potential overfitting, or otherwise improve the performance of the trained model.

One or more of the example training techniques presented above may be employed as part of a training process. As above, some example training processes that may be used to train an ML model include supervised learning, unsupervised learning, semi-supervised learning, and reinforcement learning technique.

Decentralized, distributed, or shared learning, such as federated learning, may enable training on data distributed across multiple devices or organizations, without the need to centralize data or the training. Federated learning may be particularly useful in scenarios where data is sensitive or subject to privacy constraints, or where it is impractical, inefficient, or expensive to centralize data. In the context of wireless communication, for example, federated learning may be used to improve performance by allowing an ML model to be trained on data collected from a wide range of devices and environments. For example, an ML model may be trained on data collected from a large number of wireless devices in a network, such as distributed wireless communication nodes, smartphones, or internet-of-things (IoT) devices, to improve the network's performance and efficiency. With federated learning, a user equipment (UE) or other device may receive a copy of all or part of a model and perform local training on such copy of all or part of the model using locally available training data. Such a device may provide update information (e.g., trainable parameter gradients) regarding the locally trained model to one or more other devices (such as a network entity or a server) where the updates from other-like devices (such as other UEs) may be aggregated and used to provide an update to a shared model or the like. A federated learning process may be repeated iteratively until all or part of a model obtains a satisfactory level of performance. Federated learning may enable devices to protect the privacy and security of local data, while supporting collaboration regarding training and updating of all or part of a shared model.

In some implementations, one or more devices or services may support processes relating to a ML model's training, usage, maintenance, activation, reporting, or the like. In certain instances, all or part of a dataset or model may be shared across multiple devices, e.g., to provide or otherwise augment or improve processing. In some examples, signaling mechanisms may be utilized at various nodes of a wireless network to signal the capabilities for performing specific functions related to ML model, support for specific ML models, capabilities for gathering, creating, transmitting training data, or other ML related capabilities. ML models in wireless communication systems may, for example, be employed to support decisions relating to wireless network performance, wireless resource allocation or selection, wireless channel condition estimation, interference mitigation, beam management, positioning accuracy, energy savings, or modulation or coding schemes, etc. In some implementations, model deployment may occur jointly or separately at various network levels, such as, a RIC, a CU, a DU, a RU, or the like.

### Aspects Related to Artificial Intelligence-Based Network Performance Prediction Training

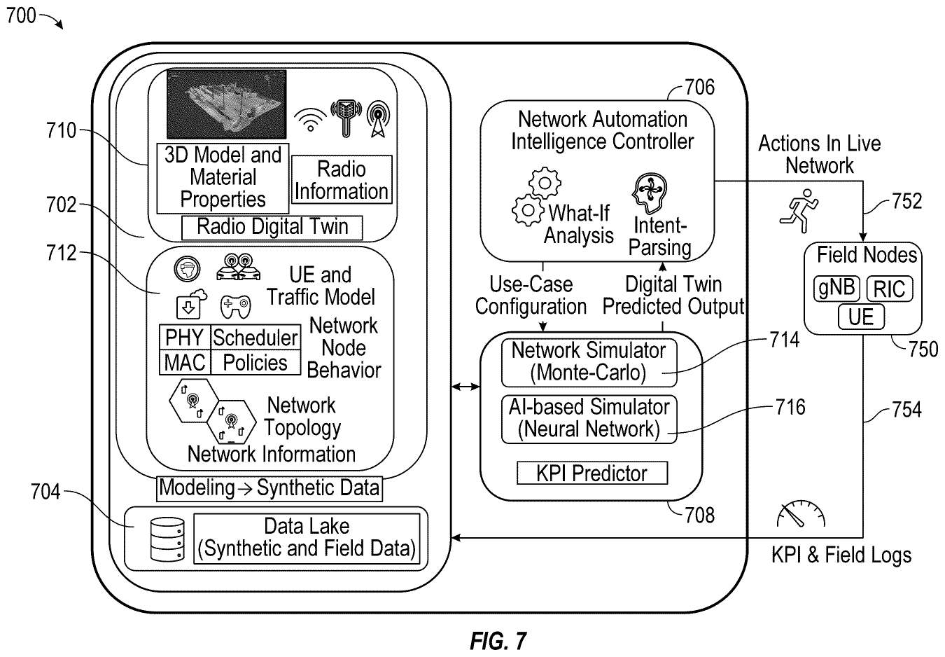

FIG. 7 depicts an example scheme for using an AI-based network simulator 700 to predict the performance of a wireless communication network. In this example, the AI-based network simulator 700 may generate or determine one or more performance predictions associated with a wireless communication network 750 (e.g., depicted as a set of field nodes). In certain cases, the wireless communication network 750 may include one or more network nodes in communication with one or more UEs, for example, as described herein with respect to FIGS. 1 and 2. In certain cases, the wireless communication network may include one or more CUs and one or more DUs, where the one or more CUs control the operations of the one or more DUs, for example, as described herein with respect to FIG. 2. In certain cases, the wireless communication network may include one or more DUs and one or more RUs, where one or more DUs control the operations of the one or more RUs, for example, as described herein with respect to FIG. 2.

The AI-based network simulator 700 may simulate the operations of the wireless communication network 750 in accordance with certain configuration(s) applied to the wireless communication network 750, for example, as further described herein.

In certain aspects, the AI-based network simulator 700 may be implemented at least in part as software components that are executed and/or run on one or more processors (e.g., the processing system 306, 316 of FIG. 3). A computing device (not shown) may run the AI-based network simulator 700 to generate or determine performance prediction(s) associated with the wireless communication network 750. The computing device may be or include a server, a computer (e.g., a laptop computer, a tablet computer, a personal computer (PC), a desktop computer, etc.), a virtual computing device (e.g., a virtual server), or any other electronic device or computing system capable of generating or determining AI-based network simulations as described herein.

As an example, the AI-based network simulator 700 may include a network model 702 (e.g., a network digital twin), a data lake 704, a network automation intelligence controller (hereinafter “the controller 706”), and a network simulator 708. The network model 702 may be a set of digital models that emulate or simulate the behavior of a wireless communication network. The network model 702 may include one or more radio models 710 (e.g., a radio digital twin) and/or certain network information 712 associated with the wireless communication network 750.

The radio model(s) may be a set of digital models that emulate or simulate the behaviors of wireless communication devices in a wireless communication network, such as one or more UEs and/or network nodes. The radio model(s) 710 may be used to determine the channel characteristics across the service area of the wireless communication network 750. For example, the radio model(s) 710 may provide or enable determination of ray tracing models, multi-path propagation models, path losses, interference profiles, round-trip-times, propagation delays, Rayleigh fading models, Doppler effects, and/or the like. The radio model(s) 710 may include a base station (network node) almanac (e.g., radio information), environment model(s) associated with the wireless communication network 750, and/or one or more UE model(s). The base station almanac (e.g., network node radio models) and/or the UE radio model(s) may include or identify one or more characteristics or properties associated with network nodes and/or UEs including, for example, the location, orientation (e.g., azimuth and/or elevation), antenna configuration, transmit power, beam shapes or radiation patterns, frequencies, bandwidths, and/or the like. In certain aspects, the UE radio model(s) may identify the type or class of the UE, for example, a smartphone, XR headset, IoT device, or the like. In certain cases, the UE radio model may identify the transceiver configuration, such as the total number of receive chains (e.g., 1, 2, or 4 receive chains), the maximum transmission power (transmission range), antenna configuration, etc.

The environment model(s) may include or identify one or more characteristics or properties associated with the physical environment in which the wireless communication network 750 is (or is expected to be) deployed. As an example, the environment model(s) may include two-dimensional, 2.5 dimensional, and/or three-dimensional environment models that provide a digital representation of various physical objects or terrain in a coordinate system. In certain aspects, the environment model(s) may identify the material characteristics (e.g., permeability and/or permittivity) associated with object(s) in the environment model(s). For outdoor environments, the objects may include buildings, trees, roads, bridges, water, greenery, and/or the like. As an example of indoor objects, the objects may include, for example, tables, chairs, sofas, walls, metallic objects (e.g., columns, piping, wiring, or the like), or the like.

The network information 712 may include or identify the protocol stack behaviors (e.g., UE and/or network node behaviors), UE traffic profiles, network node traffic profiles (e.g., traffic between nodes), network topology, and/or the like. The protocol stack behaviors may model various operations associated with the user plane and/or control plane protocol stacks, such as PHY layer procedures (e.g., upper or lower PHY layer procedures) and/or MAC procedures as discussed herein with respect to FIG. 3. The protocol stack behaviors may model or identify cell search procedures, RACH procedures, handover procedures, beam switch procedures, scheduling for communications, re-transmission procedures, and/or the like. In certain cases, the network information 712 may represent or include the distribution of UE traffic and the temporal progression or evolution of the UE traffic in the service area of the wireless communication network 750.

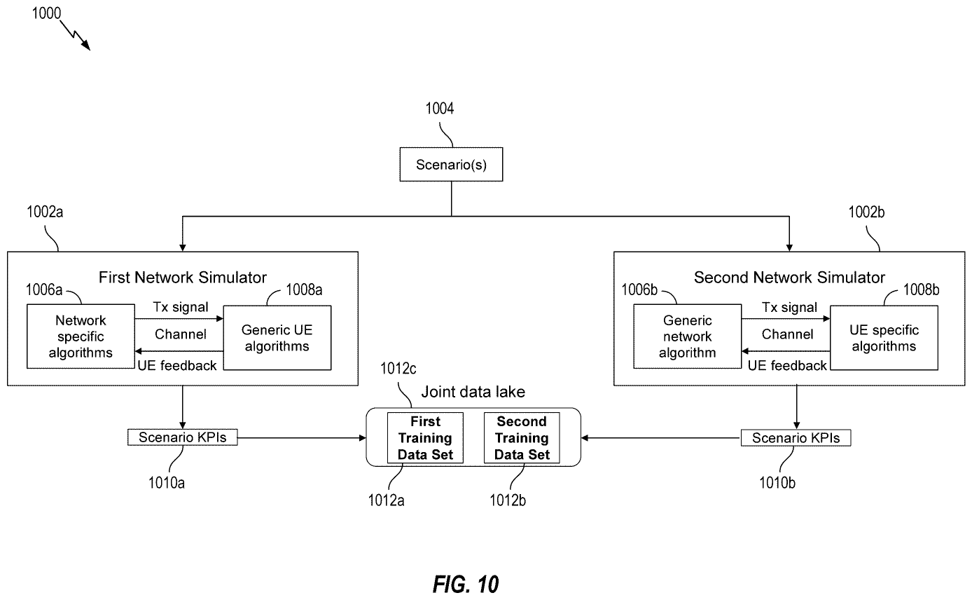

The data lake 704 may be a data structure or database that stores data associated with AI-based network simulation. The data lake 704 may store and/or enable access to certain data used to train the AI-based network simulator, generate performance predictions associated with the wireless communication network 750, and/or evaluate the performance of the AI-based network simulator 700. As an example, the data lake 704 may be an example of the data source 506 of FIG. 5. The data lake 704 may store synthetic data and/or field data 754 (e.g., observations, measurements, and/or logs captured by or at devices deployed in an end-user environment). In certain cases, synthetic training data may be generated, for example, by the network simulator 708, as further described herein with respect to FIGS. 10-12.

The network simulator 708 may be or include a Monte-Carlo simulator 714 and/or an AI-based simulator 716, as further described herein. The network simulator 708 may be in communication with the network model 702 and the data lake 704. The network simulator 708 may generate performance predictions associated with the wireless communication network 750 based on the network model 702 and/or the data lake 704. The AI-based simulator 716 may include one or more neural networks, such as the ANN of FIG. 6. The AI-based simulator 716 may be trained according to various training schemes further described herein with respect to FIGS. 10-14.

The trained AI-based simulator 716 may enable reduced latencies, increased throughput, effective channel usage, reduced power consumption, and/or the like, for example, based on the performance predictions output by the AI-based simulator 716. In certain cases, the trained AI-based simulator 716 may enable reduced processing latencies for generating or determining the performance predictions. Accordingly, the training schemes described herein may enable various beneficial technical effects and/or advantages in association with operating a wireless communication network.

In certain cases, the network simulator 708 may be referred to as a key performance indicator (KPI) predictor. In some cases, some of the performance indicators and/or performance metrics may be referred to as a KPI. However, the term “key” is not intended to invoke an “extremely or crucially important” or “necessary” meaning on any performance indicator. Rather, “key” in this context merely refers to a particular performance indicator selected for evaluating or predicting the performance of an operation or device.

In certain aspects, the controller 706 may control the operations of the network simulator 708 and/or configure network node(s) in the wireless communication network 750 based on the predictions of the network simulator. In certain cases, the controller 706 may be an example of a RIC, such as the Non-RT RIC 215 and/or the Near-RT RIC 225 of FIG. 2. In certain cases, the controller 706 may be an example of a CU, DU, RU, and/or a network node of a core network, for example, as described herein with respect to FIG. 2.

The controller 706 may provide the network simulator with a use-case configuration (for example, as part of “what-if analysis” for planning, developing, or testing the configuration). The controller 706 may obtain, from the network simulator 708, performance predictions based on the use-case configuration. As an example, the use-case configuration may define various cell shape configurations associated with a network node, and the performance predictions may indicate a particular cell shape configuration (e.g., transmit power, beam orientation, beam shape) that satisfies certain performance specifications (e.g., coverage area size, throughput, latency, power consumption, and/or the like). In certain case, the controller 706 may configure network node(s) in the wireless communication network 750 based on the performance predictions. As an example, the controller 706 may send, to the network nodes, an indication 752 to apply the particular cell shape configuration that satisfies certain performance specifications. In certain cases, the use-case configuration may be or include, for example, network node coverage planning, cell shape configuration, and/or the like. The cell shape configuration may include, for example, one or more configurations that identify the beam orientation (e.g., azimuth and/or elevation), transmit power, effective isotropic radiated power (EIRP), beam shapes (e.g., SSB beam shape and/or CSI-RS beam shape), etc. Note that aspects of the present disclosure may generate performance predictions and/or training data sets associated with additional or alternative use-case configuration(s).

Note that the AI-based network simulator 700 may represent a conceptual software architecture of a network simulator. Aspects of the present disclosure may apply to various other suitable architectures that enable generation or determination of AI-based network simulations and/or synthetic training data sets.

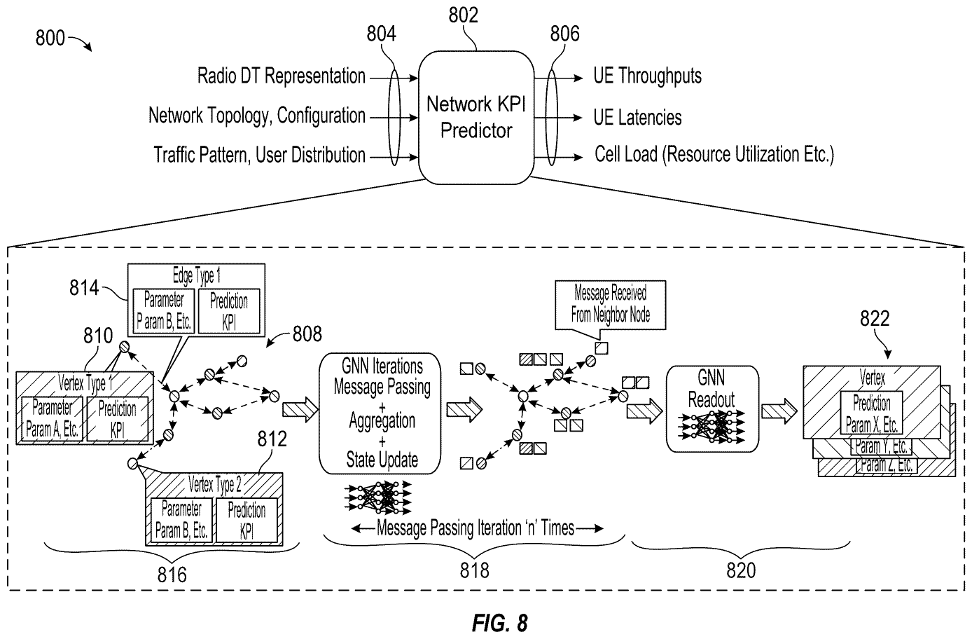

FIG. 8 depicts an example architecture 800 of an AI-based network KPI predictor. In this example, the AI-based network KPI predictor 802 may include one or more neural networks, such as the ANN 600 of FIG. 6. In certain cases, the AI-based network KPI predictor 802 may include one or more graph neural networks (GNNs) 808. The AI-based network KPI predictor may be an example of the network simulator 708 of FIG. 7.

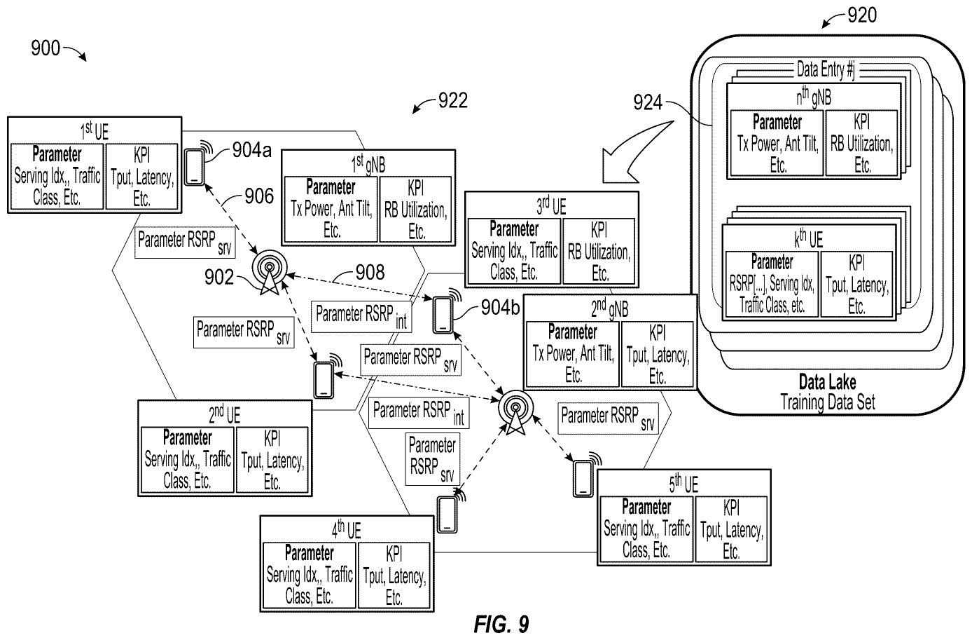

A GNN is a deep learning architecture suitable for graph structured data, offering a versatile approach for vertex, edge and graph-level predictions. The GNN 808 may model the vertices (e.g., devices) and edges (e.g., communication links and/or propagation paths associated with interference) between vertices in the graph. As an example, the UEs and network nodes in a wireless communication network (e.g., the wireless communication network 750 of FIG. 7) may be the vertices 810, 812 in the graph, and wireless communication channels (for example, between a UE and a network node) and/or network interfaces (for example, between network nodes) may be the edges 814 in the graph. In certain cases, the GNN 808 may model interference encountered in the wireless communication network as part of the graph, for example, as further described herein with respect to FIG. 9. As an example, a source of interference may be represented as a vertex, and the propagation path of the interference may be represented as an edge of the GNN 808.

The AI-based network KPI predictor 802 may obtain input data 804 including, for example, one or more configurations associated with the wireless communication network. The configuration(s) may include, for example, a representation of a radio model (e.g., a radio digital twin (DT)), a network topology, a network configuration, a UE traffic pattern, and/or a UE distribution across the service area of the wireless communication network. The input data may include any of the information described herein with respect to the network model 702, the radio model(s) 710, the network information 712, and/or the data lake 704 of FIG. 7.

The AI-based network KPI predictor 802 may provide output data 806, for example, including an indication of one or more predictions of the performance of the wireless communication network operating in accordance with the configuration(s) provided as (or included in) the input data 804. The prediction(s) may include, for example, expected UE throughputs, UE latencies, cell loads (e.g., time and/or frequency resource utilization), error rates (radio link failure, handover failure, block error rates (BLERs), and/or the like), and/or the like. In certain cases, the prediction(s) may enable slice capacity estimation and assurance, determination of network level policies for mobility, load balancing, traffic capacity levels, energy savings (e.g., power consumption), etc.

The GNN 808 may model the message passing among nodes (e.g., UEs and network nodes) in a graph data structure, as further described herein. The GNN 808 may be trained to predict the effects of neighboring vertices in a graph structure. The GNN 808 may enable the AI-based network KPI predictor 802 to learn the input-output relationship (e.g., message passing behaviors relationship) between nodes in a wireless communication network, such as a base station, a CU, a DU, a RU, a UE, and/or the like. The GNN 808 may enable the AI-based network KPI predictor 802 to be adaptable to a specific instantiation of a graph, such as a particular network topology, network deployment, and/or network configuration. The GNN 808 may include neural networks (e.g., device models) associated with certain devices (e.g., UEs and network nodes) in the wireless communication network and associated with communication links (or interference propagation paths) between the devices. The parameter values of the GNN 808 may be specified per vertex and/or per edge of the graph structure (not at the graph level). The parameter values may be independent of the graph size. Thus, the GNN 808 may be adaptable to changes or reconfigurations to the wireless communication network, such as changes to the network topology and/or coverage areas.

In certain cases, the GNN 808 may have different neural network models for the vertices in order to model the various types of UEs (e.g., smartphones, wearable devices, XR headsets, vehicles, IoT devices, and/or the like) and/or network nodes (e.g., CU, DU, RU, and/or vender specific network nodes) that can be used in the wireless communication network. In certain cases, the GNN 808 may have different neural network models for the edges in order to model the various communication links (e.g., radio link, wired link, and/or a fiber optic link), interference propagation paths, and/or one or more properties thereof (e.g., transmission range, path loss, channel conditions, interference, scattering, fading, or the like).

In certain aspects, the GNN 808 may perform multiple stages to simulate the communications (or interference encountered) among the devices in the wireless communication network and determine performance predictions associated with the wireless communication network. At a first stage 816, the GNN 808 may initialize certain hidden state vectors of the vertices and/or edges, to node-specific parameters, in the graph.

At a second stage 818, the GNN may process the state of a vertex (e.g., a neural network that models a UE and/or network node) to create a message communicated between vertices (e.g., between a UE and a network node and/or between network nodes). The GNN 808 may aggregate the messages received from neighboring nodes using an aggregation function. The GNN 808 may update the state of the vertices based on the message aggregation. The GNN 808 may perform a number of iterations to simulate communications over a specified time period. In certain cases, different iterations of message passing may use different neural networks, such as different neural networks for iterations of edge message generation and/or different neural networks for iterations of message aggregations.

At a third stage 820, the GNN 808 may output (e.g., readout) the final state of the vertices in the graph. For example, the GNN 808 may reach the final hidden state values after a certain number of iterations or after the final hidden state values satisfy a threshold. The final states of the vertices may be transformed into performance prediction(s) 822 associated with the wireless communication network. In certain cases, the neural network model associated with a vertex and/or edge of the graph may include one or more first neural networks for state creation from input, one or more second neural networks for message creation, one or more third neural networks for aggregation of received messages and state update, and/or one or more third neural networks that include a readout layer.

FIG. 9 depicts an example graph data structure 900 of a training data set 920 associated with a wireless communication network. In this example, the training data set 920 associated with a wireless communication network (e.g., the wireless communication network 750 of FIG. 7) may be represented as a graph data structure 922. The graph data structure 922 may include one or more vertices and one or more edges between the vertices. Each of the vertices may represent a device in the wireless communication network including, for example, a UE (such as the UE 904a) or a network node (such as the network node 902) in the wireless communication network. Each of the edges may represent a link between the vertices, such as a propagation path, a radio link (e.g., the radio link 906) and/or a wired link (e.g., a cable or fiber optic interface). In certain cases, an edge may be representative of the propagation path associated with interference encountered at a device (such cross-link interference and/or self-interference). As an example, the edge 908 may be representative of the interference encountered at the UE 904b from transmissions output by the network node 902, or vice versa.

The training data set 920 may include a set of data entries 924. The set of data entries 924 may indicate or include the configurations and performance (e.g., KPI(s)) associated with the devices (e.g., UEs and network nodes) in the wireless communication in association with multiple operational states. For example, the set of data entries 924 may indicate or include a first set of configurations (e.g., operating parameter(s)) and performance metrics (e.g., KPI(s)) associated with a first operational state (e.g., data entries j) of the wireless communication network, and a second set of configurations (e.g., operation parameter(s)) and performance metrics associated with a second operational state (e.g., data entries j+1). The operational state may correspond to the state of the wireless communication network at a particular instance in time and/or in accordance with a set of configurations. As an example, the training data set 920 may include a first set of operating parameters associated with a UE (such as a reference signal received power (RSRP), serving cell index or identifier, a traffic class (e.g., QoS specification(s)), and/or the like), and a second set of operating parameters associated with a network node (such as the transmit power or power consumption, coverage area, antenna orientation, and/or the like).

The training data set 920 may include a first set of performance metrics (e.g., KPIs) associated with a UE (such as throughput, latency, power consumption, and/or the like), and a second set of performance metrics associated with a network node (such as channel usage, resource block usage, throughput, latency, power consumption, and/or the like). In certain cases, the training data set 920 may include a set of characteristics associated with the edges of the graph, such as propagation delay, path losses, round-trip-times, RSRPs associated with the edges. Accordingly, the graph data structure associated with the training data set may enable training of one or more GNNs for an AI-based network simulator in association with prediction of performance of a wireless communication network as further described herein.

### Aspects Related to a Multi-Simulator Training Data Set

FIG. 10 depicts an example multi-simulator training architecture (hereinafter “the training architecture 1000”). In this example, the training architecture 1000 includes a first network simulator 1002a and a second network simulator 1002b. The network simulator(s) 1002a, 1002b may be an example of the network simulator 708 described herein with respect to FIG. 7. In certain cases, the network simulator(s) 1002a, 1002b may be or include a Monte-Carlo-based simulator and/or an AI-based simulator, for example, as described herein with respect to FIGS. 7 and 8. The network simulator(s) 1002a, 1002b may generate predictions of KPIs associated with a wireless communication network, such as the wireless communication network 100 of FIG. 1 and/or the wireless communication network 750 of FIG. 7.

In certain cases, the first network simulator 1002a and the second network simulator 1002b may be operated by the same entity or different entities, such as a network vendor, a UE vendor, a network operator, and/or any other suitable entity. In certain cases, the first network simulator 1002a may be or include a Monte-Carlo-based simulator, and the second network simulator 1002b may be or include an AI-based simulator. Accordingly, the training architecture 1000 may enable the generation of training data derived from different types of network simulators.

Each of the first network simulator 1002a and the second network simulator 1002b may generate KPI predictions associated with simulation of a wireless communication network operating, in one or more scenarios 1004, according to a respective set of configurations. As used herein, a scenario may define, identify, or include certain static or common properties used by the network simulator(s) 1002a, 1002b to simulate the operations or behaviors of the wireless communication network or any of the nodes therein. The entities operating the network simulators 1002a, 1002b may determine or agree upon the scenario(s) 1004 for simulation. In certain cases, the scenario(s) 1004 may provide sufficient details to enable the network simulator(s) 1002a, 1002b to generate KPI predictions representative of the wireless communication network operating in the respective scenario without revealing certain proprietary information. The scenario(s) 1004 may define, identify, or include one or more properties associated with the wireless communication network, and the one or more properties may be commonly applied among the first network simulator 1002a and the second network simulator 1002b. As an example, the scenario may specify a total number of UEs in a service area of the wireless communication network, a total number of network nodes in the service area, network node locations, UE locations and/or UE trajectories, coverage areas of network nodes, the network topology, physical environment models (e.g., buildings, trees, roads, indoor models, outdoor models, etc.), and/or the like. The scenario may include some of the information described herein with respect to the network model 702, the radio model(s), and/or the network information 712 of FIG. 7

The configuration(s) may be or include the operating parameters and/or behaviors associated with a device (such as a UE and/or network node) in the wireless communication network. In certain cases, a set of configurations applied to the network simulator may be specific to the particular scenario being simulated. For example, the first network simulator 1002a may apply a first set of configurations for a first scenario, and a second set of configurations for a second scenario. In certain cases, the configuration(s) may include a representation of a radio model (e.g., a radio digital twin (DT)), a network topology, a network configuration, a UE traffic pattern, and/or a UE distribution across the service area of the wireless communication network. The configuration(s) may include any of the information described herein with respect to the network model 702, the radio model(s), and/or the network information 712 of FIG. 7.

In certain cases, the first network simulator 1002a may apply a different set of configurations than the second network simulator 1002b. As an example, the first network simulator 1002a may model the network nodes using network-specific models and/or algorithms 1006a (for example, available to a network vendor), and the first network simulator may model the UEs using generic UE models or algorithms 1008b. The second network simulator 1002b may model the network nodes using generic network models or algorithms 1006b, and the second network simulator 1002b may model the UEs using UE-specific models or algorithms 1008b (for example, available to a UE vendor). Thus, in some cases, the performance prediction(s) 1010a output by or at the first network simulator 1002a may differ from the performance prediction(s) 1010b output by or at the second network simulator 1002b.

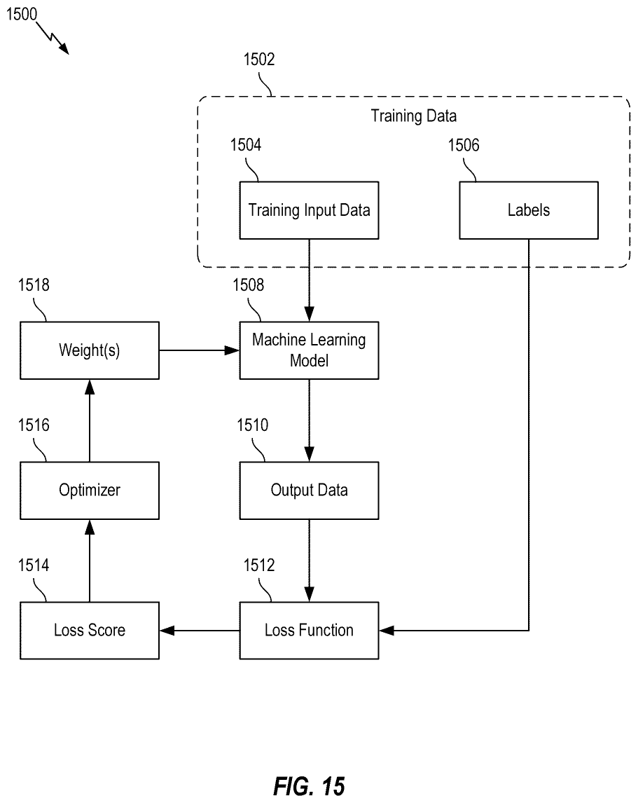

The performance prediction(s) 1010a, 1010b may be formed into a training data set, for example, mapped to the respective configurations (e.g., operating parameters) used to generate the performance predictions. As an example, the training data set may include training input data and labels (or ground truths), for example, as further described herein with respect to FIG. 15. Accordingly, the performance prediction(s) 1010a, 1010b may be represented as the labels or ground truths of a training data set, and the operating parameters or configurations, which yielded the corresponding performance prediction(s) 1010a, 1010b, may be represented as the training input data of the training data set.

A first training data set 1012a may be associated with the first network simulator 1002a, and a second training data set 1012b may be associated with the second network simulator 1002b. The first training data set 1012a may be derived from or by the first network simulator 1002a, and the second training data set 1012b may be derived from or by the second network simulator 1002b. Thus, the training data set(s) 1012a, 1012b may include synthetic training data derived from or by the network simulator(s) 1002a, 1002b, respectively.

In certain cases, a third training data set 1012c (e.g., a joint data lake) may be generated based at least in part on the first training data set 1012a and the second training data set 1012b. The third training data set may derived from the first training data set 1012a and the second training data set 1012b. The third training data set 1012c may be generated based at least in part on a comparison between the first training data set 1012a and the second training data set 1012b. In certain cases, the third training data set 1012c may be or include a selection of training data among the first training data set 1012a and the second training data set 1012b. As an example, the third training data set 1012c may be formed in part by selecting value(s) from the first training data set 1012a and/or the second training data set 1012b. As another example, the third training data set 1012c may include statistical values of the first training data set 1012a and the second training data set 1012b, such as the mean values, median values, maximum values, minimum values, standard deviation, etc. In certain cases, the training data set(s) 1012a, 1012b, 1012c may be an example of the training data 516 of FIG. 5 and/or the training data set 920 of FIG. 9.

The training data set(s) 1012a, 1012b, 1012c may be used to train an AI-based network simulator, such as the AI-based network KPI predictor 802 of FIG. 8. In certain aspects, the training data sets 1012a, 1012b, 1012c may be formed into or represented in a graph data structure, for example, as described herein with respect to FIG. 9. In certain cases, the training architecture 1000 may enable generation of training data sets associated with multiple network simulators (such as the first network simulator 1002a and the second network simulator 1002b), which may be operating according to different configuration(s) as described herein. The third training data set may enable improved accuracy of the synthetic performance predictions, which in turn may improve the accuracy of the trained AI-based network simulator. Accordingly, the training architecture 1000 may enable reduced latencies, increased throughput, effective channel usage, reduced power consumption, simulator adaptability, reduced processing latencies, and/or the like.

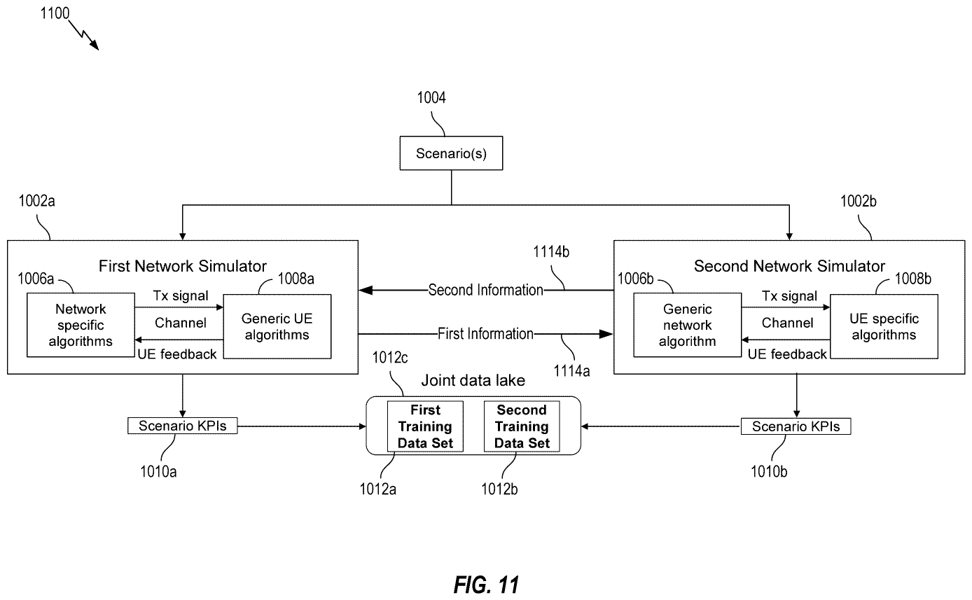

FIG. 11 depicts another example multi-simulator training architecture (hereinafter “the training architecture 1100”). In this example, the training architecture 1100 may have the same general architecture as the training architecture 1000 of FIG. 10 (for example, as indicated by the same reference numerals), except certain information may be exchanged or communicated between the first network simulator 1002a and the second network simulator 1002b.

As an example, the second network simulator 1002b may obtain an indication of first information 1114a associated with the generation of the first training data set 1012a, for example, at least in part by the first network simulator 1102a. The first information 1114a may indicate or include at least one configuration of the configuration(s) (e.g., the scenario-specific configuration(s)) applied at the first network simulator 1002a in association with simulation of the wireless communication network in a specific scenario (e.g., the scenario(s) 1004). As another example, the first network simulator 1002a may obtain an indication of second information 1114b associated with the generation of the second training data set 1012b, for example, at least in part by the second network simulator 1002b. The first information 1114a and/or the second information 1114b may indicate or include outer loop adaptation parameters (e.g., associated with device behavior modeling), channel state information (CSI) communicated between a UE and a network node (or CSI measurement and/or reporting configuration(s)), one or more link curves associated with control and/or data decoding, and/or one or more path losses associated with a communication link between a UE and a network node. The shared information (the first information 1114a and/or the second information 1114b) may enable improved accuracy of the synthetic performance predictions. For example, the shared information may enable the network simulators 1002a, 1002b to run simulations using consistent configurations associated with the devices in the wireless communication network, which may reduce discrepancies between the first training data set 1012a and the second training data set 1012b and enable a more accurate representation of the third training data set 1012c. Accordingly, the training architecture 1100 may enable reduced latencies, increased throughput, effective channel usage, reduced power consumption, simulator adaptability, reduced processing latencies, and/or the like.

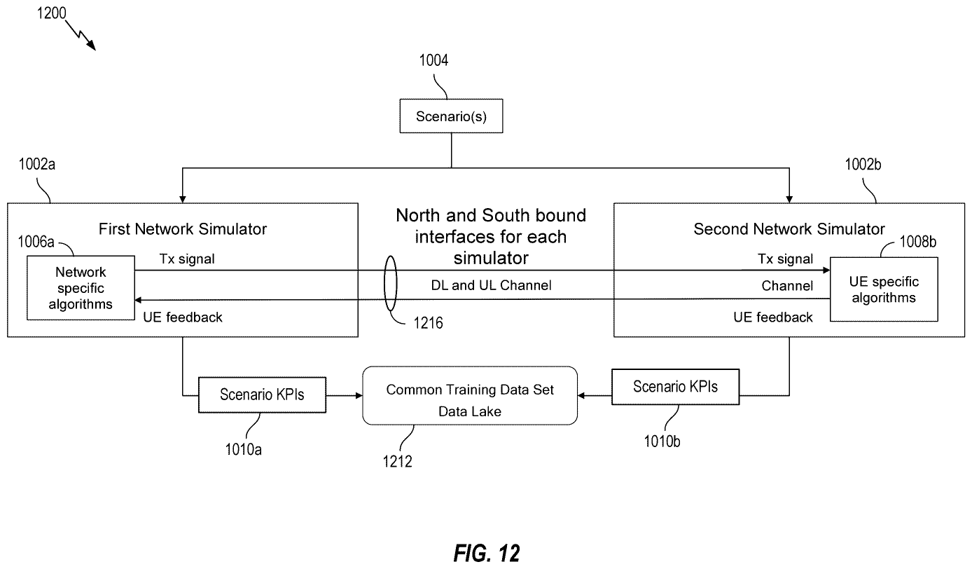

FIG. 12 depicts another example multi-simulator training architecture (hereinafter “the training architecture 1200”). In this example, the training architecture 1200 may have the same general architecture as the training architecture 1000 of FIG. 10 (for example, as indicated by the same reference numerals), except certain information 1216 may be exchanged or communicated between the network simulators 1002a, 1002b. As an example, the first network simulator 1002a may simulate the communications of one or more network nodes, for example, based on network-specific models and/or algorithms 1006a; and the second network simulator 1002b may simulate the communications of one or more UEs, for example, based on UE-specific models and/or algorithms 1008b. In certain aspects, the simulated communications may include a simulation of transmissions communicated over one or more time periods, such as a set of slots (e.g., corresponding to slot by slot transmissions). In certain cases, there may be northbound and southbound interfaces for exchanging simulated signaling between the network simulators 1002a, 1002b. The interfaces may be logical or physical communication interfaces used to transfer communications between the network simulators 1002a, 1002b.

The simulated communications may enable further improved accuracy of the synthetic performance predictions, which in turn may further improve the accuracy of the trained AI-based network simulator. For example, due to the communications being simulated between the device specific algorithms or models (e.g., 1006a, 1008b), the training architecture 1200 may provide a more accurate representation of the performance of the wireless communication network. Accordingly, the training architecture 1200 may enable reduced latencies, increased throughput, effective channel usage, reduced power consumption, simulator adaptability, reduced processing latencies, and/or the like.

The information 1216 exchanged or communicated between the network simulators 1002a, 1002b may include an indication of signaling (such as downlink and/or uplink signaling) communicated between a UE and a network node. In certain cases, the information 1216 may include an indication of one or more wireless communication channels between the UE and the network node. In certain cases, the information 1216 may include an indication of one or more subcarriers associated with multi-carrier communications (e.g., OFDM communications) between the UE and the network node. In certain cases, the information 1216 may include an indication of baseband signaling (such as in-phase and quadrature baseband signaling communicated over the channel) communicated between the UE and the network node. The performance prediction(s) 1010a, 1010b may form a common training data set 1212, such as the third training data set 1012c described herein with respect to FIG. 10.

### Example Signaling Related to Artificial Intelligence-Based Network Performance Prediction Training

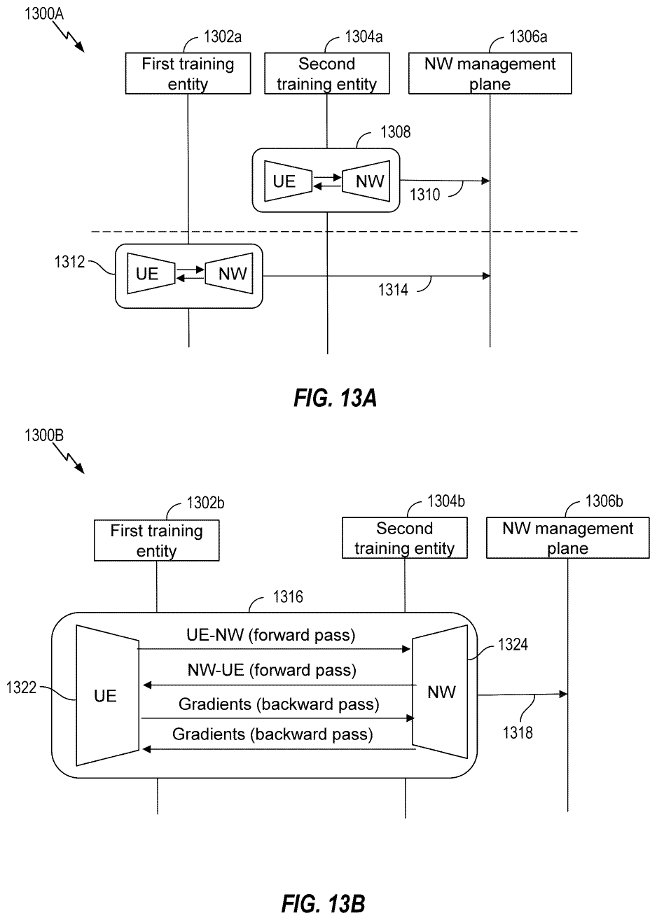

FIG. 13A depicts a process flow 1300A for communication of signaling related to training an AI-based network simulator in a system including a first training entity 1302a, a second training entity 1304a, and a network management plane 1306a. In certain aspects, the training entity 1302a, 1304a may be an example of a computing device (for example, as described herein with respect to FIG. 7). In certain aspects, the training entity 1302a, 1304a may be an example of the BS 102 depicted and described with respect to FIG. 1, the first network entity 300 or the second network entity 302 depicted and described with respect to FIG. 3, or a disaggregated base station depicted and described with respect to FIG. 2. In certain aspects, the training entity 1302a, 1304a may be an example of UE 104 depicted and described with respect to FIG. 1 or the UE 304 depicted and described with respect to FIG. 3.

In certain aspects, the network management plane 1306a may be an example of a core network (such as the 5GC 190 of FIG. 1) or an entity thereof. In certain aspects, the network management plane 1306a may be an example of the BS 102 depicted and described with respect to FIG. 1, the first network entity 300 or the second network entity 302 depicted and described with respect to FIG. 3, or a disaggregated base station depicted and described with respect to FIG. 2. In certain aspects, the network management plane 1306a may be an example of the SMO Framework 205 of FIG. 2.

In certain cases, the first training entity 1302a may be an example of a UE vendor entity, and the second training entity 1304a may be an example of network vendor entity. In certain cases, the first training entity 1302a and/or the second training entity 1304a may have (or have access to) any of the training data sets (or a subset thereof) described herein with respect to FIGS. 10-12. As an example, the first training entity 1302a may have access to the second training data set 1012b and the third training data set 1012c; and the second training entity 1304b may have access to the first training data set 1012a and the third training data set 1012c.

At 1308, the second training entity 1304a trains one or more first ML models based at least in part on the second training data set 1012b and/or the third training data set 1012c, for example, as further described herein with respect to FIG. 15. In certain cases, the first ML model(s) may be or include one or more GNNs, for example, as described herein with respect to FIG. 9. The first ML model(s) may include one or more first neural networks associated with UE(s) and one or more second neural networks associated with network nodes (labeled as NW). As an example, the first ML model(s) may perform one or more iterations of GNN message passing, such as device state generation, device message generation, device message aggregation, and device state update associated with a UE and/or network node.

At 1310, the second training entity 1304a optionally sends, to the network management plane 1306a, the trained first ML model(s). The network management plane 1306a may use the trained first ML model(s) to configure a wireless communication network, for example, as described herein with respect to FIG. 7.

At 1312, the first training entity 1302a trains one or more second ML models based at least in part on the first training data set 1012a and/or the third training data set 1012c, for example, as further described herein with respect to FIG. 15.

At 1314, the first training entity 1302a optionally sends, to the network management plane 1306a, the trained second ML model(s). In certain cases, the network management plane 1306a may use the trained second ML model(s) to configure a wireless communications network, for example, as described herein with respect to FIG. 7. Accordingly, the trained ML model(s) may enable reduced latencies, increased throughput, effective channel usage, reduced power consumption, simulator adaptability, reduced processing latencies, and/or the like.

FIG. 13B depicts another process flow 1300B for communication of signaling related to training an AI-based network simulator in a system including a first training entity 1302b, a second training entity 1304b, and a network management plane 1306b. In this example, the first training entity 1302a, the second training entity 1304b, and the network management plane 1306b may be examples of the first training entity 1302a, the second training entity 1304a, and the network management plane 1306b of FIG. 13A.

In certain cases, the first training entity 1302b may be an example of a UE vendor entity, and the second training entity 1304b may be an example of network vendor entity. In certain cases, the first training entity 1302b and/or the second training entity 1304b may have (or have access to) any of the training data sets (or a subset thereof) described herein with respect to FIGS. 10-12. As an example, the first training entity 1302b may have access to the first training data set 1012a and the third training data set 1012c; and the second training entity 1304b may have access to the second training data set 1012b and the third training data set 1012c.

The first training entity 1302b may have (or have access to) one or more first ML models 1322 associated with one or more UEs, such as the neural network model(s) associated with UEs in a GNN. The second training entity 1304b may have (or have access to) one or more second ML models 1324 associated with one or more network nodes, such as the one or more neural networks associated network nodes in the GNN.

At 1316, the first training entity 1302b and the second training entity 1304b collaborate to train one or ML models including the first ML models(s) 1322 and the second ML model(s) 1324. As an example, the first training entity 1302b obtains a first set of forward pass information and backward pass information associated with the second ML model(s) 1324. The first training entity may train the first ML models 1322 based at least in part on the first set of forward pass information and backward pass information, for example, as further described herein with respect to FIG. 15. The first training entity 1302b may determine the loss or cost function based on the training data set(s) available or accessible to the first training entity 1302b.

The second training entity 1304b obtains a second set of forward pass information and backward pass information associated with the first ML model(s) 1322. The second training entity 1304b may train the second ML model(s) 1324 associated with the network node based on the second set of forward pass information and backward pass information, for example, as further described herein with respect to FIG. 15. The second training entity 1304b may determine the loss or cost function based on the training data set(s) available or accessible to the second training entity 1304b.

At 1318, the network management plane 1306b obtains the trained ML model(s), which may include the trained first ML model(s) 1322 and the trained second ML model(s) 1324. The network management plane 1306b may use the trained ML model(s) to configure a wireless communications network, for example, as described herein with respect to FIG. 7. Accordingly, the trained ML model(s) may enable reduced latencies, increased throughput, effective channel usage, reduced power consumption, simulator adaptability, reduced processing latencies, and/or the like.

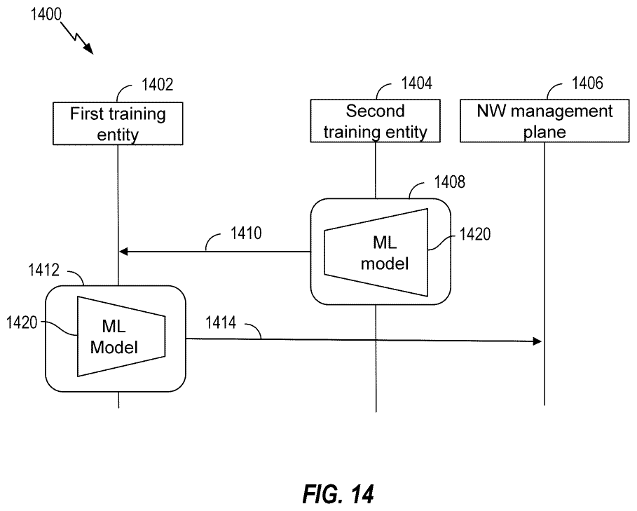

FIG. 14 depicts a process flow 1400 for communication of signaling related to training an AI-based network simulator in a system including a first training entity 1402, a second training entity 1404, and a network management plane 1406. In this example, the first training entity 1402, the second training entity 1404, and the network management plane 1406 may be examples of the first training entity 1302a, the second training entity 1304a, and the network management plane 1306a of FIG. 13A.

In certain cases, the first training entity 1402 may be an example of a UE vendor entity, and the second training entity 1404 may be an example of a network vendor entity. In certain cases, the first training entity 1402 and/or the second training entity 1404 may have (or have access to) any of the training data sets (or a subset thereof) described herein with respect to FIGS. 10-12. As an example, the first training entity 1402 may have access to the second training data set 1012b and the third training data set 1012c; and the second training entity 1404 may have access to the first training data set 1012a and the third training data set 1012c.

At 1408, the second training entity 1404 trains one or more ML models 1420 based on the training data available or accessible to the second training entity 1404, such as the first training data set and/or the third training data set.

At 1410, the first training entity 1402 obtains, from the second training entity, the trained ML model(s) 1420.

At 1412, the first training entity 1402 further trains the ML model(s) 1420 based on the training data available or accessible to the first training entity 1402, such as the second training data set and/or the third training data set. As an example, the first training entity 1402 may refine the training of the ML model(s) 1420. In certain cases, the first training entity 1402 may train only neural networks associated with UEs in the ML model(s), and thus, the first training entity 1402 may refrain from training neural networks associated with a network node. In certain cases, the first training entity 1402 may train any of the neural networks in the ML model(s), such as neural networks associated with a network node, and/or neural networks associated with a UE.

At 1412, the network management plane obtains the trained ML model(s), which may include the trained first ML model(s) and the trained second ML model(s). The network management plane 1406 may use the trained ML model(s) to configure a wireless communications network, for example, as described herein with respect to FIG. 7.

Note that the process flows illustrated in FIGS. 13A, 13B, and 14 are examples of training ML model(s), and aspects of the present disclosure may be applied to other suitable techniques of training ML model(s). Note that the process flows illustrated in FIGS. 13A, 13B, and 14 are described herein to facilitate an understanding of training AI-based network performance prediction, and aspects of the present disclosure may be performed in various manners via alternative or additional signaling and/or operations. In certain aspects, the operations and/or signaling of FIGS. 13A, 13B, and 14 may occur in an order different from that described or depicted, and various actions, operations, and/or signaling may be added, omitted, or combined.

### Aspects of Training a Machine Learning Model for a Network Simulator

FIG. 15 depicts an example architecture 1500 for training an ML model for network performance simulation. The architecture 1500 may be implemented by a model training host (e.g., the model training host 502 of FIG. 5). In certain cases, the model training host may be or include a UE and/or a network node. In certain cases, the model training host may be or include a processing system (e.g., the processing system 306 of FIG. 3) configured to perform certain life cycle management task(s) associated with ML model(s) deployed at a UE and/or network node. As an example, the model training host may be or include a model server, which may collect training data from one or more wireless communications devices (e.g., a UE and/or network node). In certain cases, the model training data host may collect synthetic training data derived from a network simulator, for example, as described herein with respect to FIGS. 10-12. The model training host may perform the ML model training as described herein with respect to FIGS. 13A, 13B, and 14.

The model training host may obtain training data 1502 including training input data 1504 and/or corresponding labels 1506 for the training input data 1504. The training input data 1504 may include any of the training data sets (or a subset thereof) described herein with respect to FIGS. 10-12. The training input data 1504 may be simulated (e.g., computer generated) and/or collected from field data (e.g., performance logs) of a UE and/or network vendor, for example, under various operating conditions, as further discussed herein.

The model training host may use the labels 1506 to evaluate the performance of an ML model 1508 and adjust the ML model 1508 (e.g., weights of the ANN 600) as described herein. Each of the labels 1506 may be associated with a sample of the training input data 1504. In certain cases, each of the labels 1506 may include an expected performance prediction for the respective sample. The sample of the training input data may indicate or include configuration(s) and/or operating parameters associated with a device in a wireless communication network, for example, as described herein with respect to FIG. 9.

The model training host provides the training input data 1504 to the ML model 1508. In certain aspects, the ML model 1508 may include a neural network. The ML model 1508 may be an example of the ML model(s) described herein with respect to FIGS. 5-8. The ML model 1508 provides output data 1510, which may include an indication of one or more performance predictions associated with a wireless communication network, for example, as described herein with respect to FIGS. 7 and 8.

The model training host may evaluate the performance of the ML model 1508 and determine whether to update the ML model 1508, for example, based on the labels 1506. The model training host may evaluate the quality and/or accuracy of the output data 1510. In some cases, the model training host may determine whether the output data 1510 matches the corresponding label 1506 of the training input data 1504. For example, the model training host may determine whether the performance predictions (e.g., predicted throughput) output by the ML model 1508 matches the expected performance parameter (e.g., the labeled or expected throughput) of the corresponding label 1506.

In certain aspects, the model training host may evaluate the performance of the ML model 1508 using a cost or loss function 1512 (hereinafter “the loss function 1512”). The loss function 1512 may be or include a comparison between the expected performance parameter corresponding to the label 1506 and the performance prediction output by the ML model 1508. In certain aspects, the loss function 1512 may be or include a difference between the performance prediction output by the ML model 1508 and the expected performance corresponding to the label 1506, for example, as a mean squared error between the respective performance metrics. The loss function 1512 may provide a loss value or score 1514 based on the comparison of the output data 1510 and the label 1506.

The model training host may provide the loss score 1514 to an optimizer 1516, which may determine one or more updated weights 1518 for the ML model 1508. The optimizer 1516 may adjust the ML model 1508 (e.g., any of the weights in a layer of a neural network) to reduce the loss score 1514 associated with the ML model 1508. In certain aspects, the optimizer 1516 may perform backpropagation to determine the updated weights 1518. The model training host may continue to provide the training input data 1504 to the ML model 1508 and adjust the ML model 1508 using the weights 1518 until the loss score 1514 of the ML model 1508 satisfies a threshold and/or reaches a specific value (e.g., a minimum value) or after a certain number of training iterations. The model training host may perform online training of the ML model 1508 or train the ML model 1508 using one or more batches of training data 1502. In certain aspects, the optimizer 1516 may be or include a root mean square propagation (RMSprop) optimizer, a descent gradient optimizer (e.g., a stochastic descent gradient (SGD)), a momentum optimizer, an Adam optimizer, or like to minimize or reduce the loss score 1514 associated with the AI-based network simulation.

In certain aspects, the model training host may train multiple ML models to perform AI-based network simulation, as described herein with respect to FIGS. 7 and 8. The ML models may be trained or configured with different model performance characteristics, different model configurations (e.g., a UE model and/or a network node model in a GNN), and/or different input-output schemes (e.g., different input data and different output data). For example, the ML models may be trained to generate performance predictions associated with a wireless communication network with different levels of accuracy (e.g., accuracies of 80%, 95%, or 99%) of meeting a target performance metric and/or different latencies (e.g., the processing time to generate the performance predictions). Thus, the ML model may be selected among multiple trained ML models in accordance with certain performance characteristic(s), configurations, and/or input-output schemes as described herein.

Note that the training architecture 1500 is an example of deep learning to facilitate an understanding of training an ML model for AI-based network simulation. Any suitable training architecture may be used in addition to or instead of the training architecture 1500 to train the ML model(s) described herein.

### Example Operations of Artificial Intelligence-Based Network Performance Prediction Training

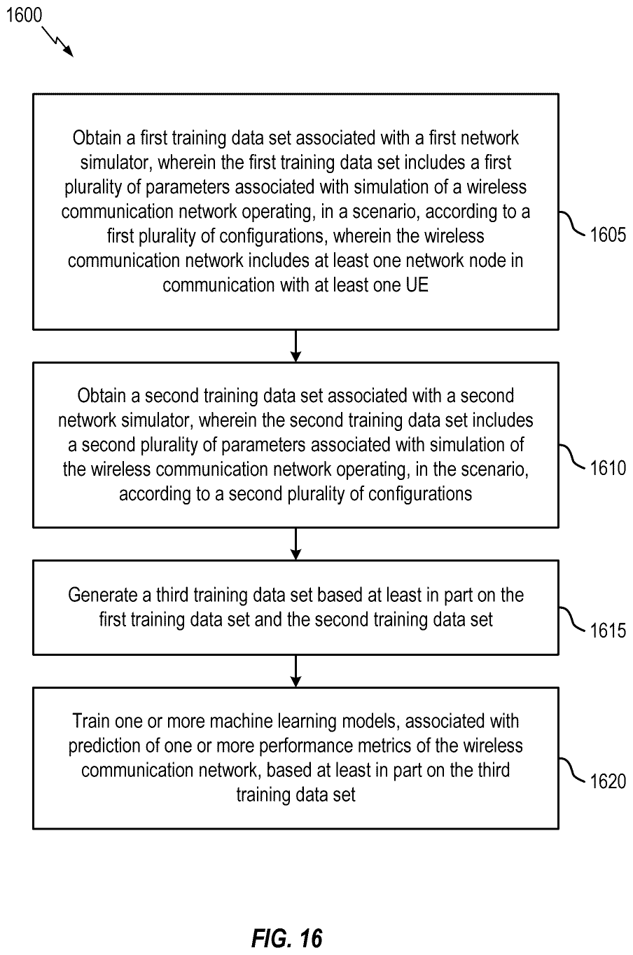

FIG. 16 shows a method 1600 for wireless communications by an apparatus, such as UE 104 of FIG. 1, UE 304 of FIG. 3, BS 102 of FIG. 1, a first network entity 300 or second network entity 302 of FIG. 3, and/or a disaggregated base station as discussed with respect to FIG. 2. The apparatus may be an example of a computing device, for example, as described herein with respected to FIG. 7.

Method 1600 begins at block 1605 with obtaining a first training data set associated with a first network simulator, wherein the first training data set includes a first plurality of parameters associated with simulation of a wireless communication network operating, in a scenario, according to a first plurality of configurations, wherein the wireless communication network includes at least one network node in communication with at least one UE, for example, as described herein with respect to FIGS. 10-12.

Method 1600 then proceeds to block 1610 with obtaining a second training data set associated with a second network simulator, wherein the second training data set includes a second plurality of parameters associated with simulation of the wireless communication network operating, in the scenario, according to a second plurality of configurations, for example, as described herein with respect to FIGS. 10-12.

Method 1600 then proceeds to block 1615 with generating a third training data set based at least in part on the first training data set and the second training data set, for example, as described herein with respect to FIGS. 10-12.

Method 1600 then proceeds to block 1620 with training one or more machine learning models, associated with prediction of one or more performance metrics of the wireless communication network, based at least in part on the third training data set, for example, as described herein with respect to FIGS. 13A-15.

In some aspects, the scenario defines one or more properties associated with the wireless communication network, wherein the one or more properties are commonly applied among the first network simulator and the second network simulator.

In some aspects, block 1605 includes: configuring the first network simulator to output a set of performance metrics associated with simulation of the wireless communication network operating, in the scenario, according to the first plurality of configurations; obtaining the set of performance metrics from the configured first network simulator; and generating the first training data set based at least in part on the set of performance metrics and the first plurality of configurations.

In some aspects, block 1620 includes: providing, to the one or more machine learning models, training input data, wherein the third training data set comprises the training input data and a set of training labels associated with the training input data; obtaining, from the one or more machine learning models, output data based at least in part on the training input data; and configuring the one or more machine learning models based at least in part on a comparison between the output data and the set of training labels.

In some aspects, the first plurality of parameters includes one or more of: a first set of operating parameters associated with the at least one network node; a second set of operating parameters associated with the at least one UE; a first set of performance metrics associated with the at least one network node; or a second set of performance metrics associated with the at least one UE.

In some aspects, the first training data set forms a graph data structure associated with the scenario; the plurality of first parameters includes a first set of parameters associated with one or more vertices in the graph data structure and a second set of parameters associated with one or more links in the graph data structure; the one or more vertices includes the at least one network node and the at least one UE; and the one or more links includes a serving link between the at least one network node and the at least one UE.

In some aspects, the one or more machine learning models comprises one or more graph neural networks.

In some aspects, the one or more graph neural networks comprise a first neural network associated with the at least one network node and a second neural network associated with the at least one UE.

In some aspects, the first network simulator comprises a Monte Carlo-based network simulator.

In some aspects, the first training data set is derived from the first network simulator; the second training data set is derived from the second network simulator; and block 1615 includes generating the third training data set based at least in part on a comparison between the first training data set and the second training data set.

In some aspects, the comparison comprises a comparison of statistical values among the first training data set and the second training data set.

In some aspects, block 1605 includes: obtaining an indication of first information associated with generation of the second training data set, wherein the first information includes at least one configuration of the second plurality of configurations; and configuring the first network simulator to apply the first plurality of configurations, including the at least one configuration, in association with simulation of the wireless communication network.

In some aspects, the first information includes one or more of: one or more outer loop adaptation parameters; channel state feedback communicated between the at least one UE and the at least one network node; one or more link curves associated with signaling decoding; or one or more path losses associated with a communication link between the at least one UE and the at least one network node.

In some aspects, block 1610 includes: sending an indication of second information associated with generation of the first training data set; and obtaining the second training data set after communication of the indication of the second information.

In some aspects, the first information comprises one or more of: an indication of signaling communicated between the at least one UE and the at least one network node; an indication of one or more wireless communication channels between the at least one UE and the at least one network node; an indication of one or more subcarriers associated with multi-carrier communications between the at least one UE and the at least one network node; or an indication of baseband signaling communicated between the at least one UE and the at least one network node.

In some aspects, the one or more machine learning models comprise a neural network that includes a first set of machine learning models associated with the at least one network node and a second set of machine learning models associated with the at least one UE; and block 1620 includes: training the first set of machine learning models of the neural network based at least in part on the third training data set; and training the second set of machine learning models of the neural network, comprising the trained first set of machine learning models, based at least in part on a fourth training data set derived from the first training data set and the second training data set.

In some aspects, the one or more machine learning models comprise a neural network that includes a first set of machine learning models associated with the at least one network node and a second set of machine learning models associated with the at least one UE; and block 1620 includes: training the first set of machine learning models of the neural network based at least in part on the third training data set; and training the second set of machine learning models and the first set of machine learning models based at least in part on a fourth training data set derived from the first training data set and the second training data set.

In some aspects, block 1620 includes: training a first set of machine learning models of the one or more machine learning models based at least in part on the third training data set; or training a second set of machine learning models of the one or more machine learning models based at least in part on a fourth training data set derived from the first training data set and the second training data set.

In some aspects, the one or more machine learning models comprise a neural network that includes a first set of machine learning models associated with the at least one network node and a second set of machine learning models associated with the at least one UE; and block 1620 includes: communicating one or more of: (i) forward pass information associated with one or more of the first set of machine learn models or the second set of machine learning models, or (ii) backpropagation information associated with one or more of the first set of machine learning models and the second set of machine learning models; and training the one or more machine learning models further based at least in part on one or more of the forward pass information or the backpropagation information.

In some aspects, method 1600 further includes providing, to the one or more machine learning models, input data.

In some aspects, method 1600 further includes obtaining, from the one or more machine learning models, output data that indicates the one or more performance metrics associated with the wireless communication network.

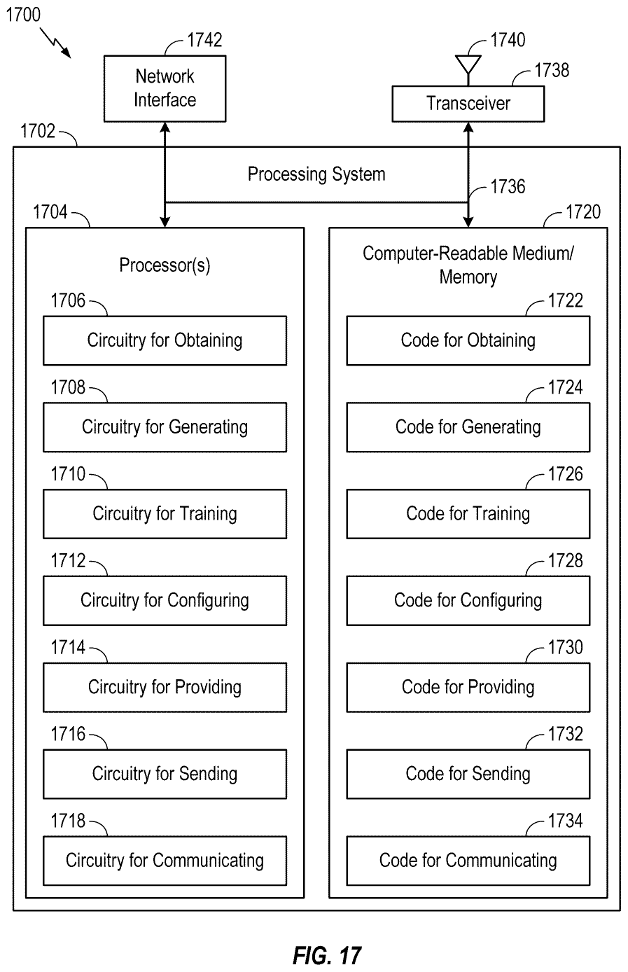

In some aspects, method 1600, or any aspect related to it, may be performed by an apparatus, such as communications device 1700 of FIG. 17, which includes various components operable, configured, or adapted to perform the method 1600. Communications device 1700 is described below in further detail.

Note that FIG. 16 is just one example of a method, and other methods including fewer, additional, or alternative operations are possible consistent with this disclosure.

### Example Communications Devices

FIG. 17 depicts aspects of an example communications device 1700 configured for wireless communications. In some aspects, communications device 1700 is a user equipment, such as UE 104 described above with respect to FIG. 1 or UE 304 described with respect to FIG. 3. In some aspects, communications device 1700 is a network entity, such as BS 102 of FIG. 1, first network entity 300 or second network entity of FIG. 3, or a disaggregated base station as discussed with respect to FIG. 2. The communications device may be an example of a computing device, for example, as described herein with respected to FIG. 7.

The communications device 1700 includes a processing system 1702 coupled to a transceiver 1738 (e.g., a transmitter and/or a receiver) and/or a network interface 1742. The transceiver 1738 is configured to transmit and receive signals for the communications device 1700 via an antenna 1740, such as the various signals as described herein. The network interface 1742 is configured to obtain and send signals for the communications device 1700 via communications link(s), such as a backhaul link, midhaul link, and/or fronthaul link as described herein, such as with respect to FIG. 2. The processing system 1702 may be configured to perform processing functions for the communications device 1700, including processing signals received and/or to be transmitted by the communications device 1700.

The processing system 1702 includes one or more processors 1704 and a computer-readable medium/memory 1720. In various aspects, the one or more processors 1704 may be representative of the one or more processors 318 described with respect to FIG. 3. The one or more processors 1704 are coupled to a computer-readable medium/memory 1720 via a bus 1736. In some aspects, the computer-readable medium/memory 1720 may be representative of the one or more memories 320 described with respect to FIG. 3. The computer-readable medium/memory 1720 is a non-transitory computer-readable medium/memory. In certain aspects, the computer-readable medium/memory 1720 is configured to store instructions (e.g., computer-executable code), that when executed by the one or more processors 1704, cause the one or more processors 1704 to perform the method 1600 described with respect to FIG. 16, or any aspect related to it, including any operations described in relation to FIG. 16. Note that reference to a processor performing a function of communications device 1700 may include one or more processors performing that function of communications device 1700, such as in a distributed fashion.

In the depicted example, computer-readable medium/memory 1720 stores code (e.g., executable instructions), including code for obtaining 1722, code for generating 1724, code for training 1726, code for configuring 1728, code for providing 1730, code for sending 1732, and code for communicating 1734. Processing of the code 1722-1734 may enable and cause the communications device 1700 to perform the method 1600 described with respect to FIG. 16, or any aspect related to it. For instance, in some aspects, code for obtaining 1722 includes code for obtaining a first training data set associated with a first network simulator, wherein the first training data set includes a first plurality of parameters associated with simulation of a wireless communication network operating, in a scenario, according to a first plurality of configurations, wherein the wireless communication network includes at least one network node in communication with at least one UE. In some aspects, code for obtaining 1722 includes code for obtaining a second training data set associated with a second network simulator, wherein the second training data set includes a second plurality of parameters associated with simulation of the wireless communication network operating, in the scenario, according to a second plurality of configurations. In some aspects, code for generating 1724 includes code for generating a third training data set based at least in part on the first training data set and the second training data set. In some aspects, code for training 1726 includes code for training one or more machine learning models, associated with prediction of one or more performance metrics of the wireless communication network, based at least in part on the third training data set.

The one or more processors 1704 include circuitry configured to implement (e.g., execute) the code stored in the computer-readable medium/memory 1720, including circuitry for obtaining 1706, circuitry for generating 1708, circuitry for training 1710, circuitry for configuring 1712, circuitry for providing 1714, circuitry for sending 1716, and circuitry for communicating 1718. Processing with circuitry 1706-1718 may enable and cause the communications device 1700 to perform the method 1600 described with respect to FIG. 16, or any aspect related to it. For instance, in some aspects, circuitry for obtaining 1706 includes circuitry for obtaining a first training data set associated with a first network simulator, wherein the first training data set includes a first plurality of parameters associated with simulation of a wireless communication network operating, in a scenario, according to a first plurality of configurations, wherein the wireless communication network includes at least one network node in communication with at least one UE. In some aspects, circuitry for obtaining 1706 includes circuitry for obtaining a second training data set associated with a second network simulator, wherein the second training data set includes a second plurality of parameters associated with simulation of the wireless communication network operating, in the scenario, according to a second plurality of configurations. In some aspects, circuitry for generating 1708 includes circuitry for generating a third training data set based at least in part on the first training data set and the second training data set. In some aspects, circuitry for training 1710 includes circuitry for training one or more machine learning models, associated with prediction of one or more performance metrics of the wireless communication network, based at least in part on the third training data set.

More generally, means for communicating, transmitting, sending or outputting for transmission may include the one or more transceivers 324, one or more antennas 322, and/or processing system 316 of the UE 304 illustrated in FIG. 3, transceiver 1738, and/or antenna 1740, of the communications device 1700 in FIG. 17; and/or one or more processors 1704 of the communications device 1700 in FIG. 17. Means for communicating, receiving or obtaining may include the one or more transceivers 324, one or more antennas 322, and/or processing system 316 of the UE 304 illustrated in FIG. 3, transceiver 1738, and/or antenna 1740, of the communications device 1700 in FIG. 17; and/or one or more processors 1704 of the communications device 1700 in FIG. 17.

### Example Clauses

Implementation examples are described in the following numbered clauses:

Clause 1: A method for wireless communications by an apparatus comprising: obtaining a first training data set associated with a first network simulator, wherein the first training data set includes a first plurality of parameters associated with simulation of a wireless communication network operating, in a scenario, according to a first plurality of configurations, wherein the wireless communication network includes at least one network node in communication with at least one UE; obtaining a second training data set associated with a second network simulator, wherein the second training data set includes a second plurality of parameters associated with simulation of the wireless communication network operating, in the scenario, according to a second plurality of configurations; generating a third training data set based at least in part on the first training data set and the second training data set; and training one or more machine learning models, associated with prediction of one or more performance metrics of the wireless communication network, based at least in part on the third training data set.

Clause 2: The method of Clause 1, wherein the scenario defines one or more properties associated with the wireless communication network, wherein the one or more properties are commonly applied among the first network simulator and the second network simulator.

Clause 3: The method of any one of Clauses 1-2, wherein obtaining the first training data set comprises: configuring the first network simulator to output a set of performance metrics associated with simulation of the wireless communication network operating, in the scenario, according to the first plurality of configurations; obtaining the set of performance metrics from the configured first network simulator; and generating the first training data set based at least in part on the set of performance metrics and the first plurality of configurations.

Clause 4: The method of any one of Clauses 1-3, wherein training the one or more machine learning models comprises: providing, to the one or more machine learning models, training input data, wherein the third training data set comprises the training input data and a set of training labels associated with the training input data; obtaining, from the one or more machine learning models, output data based at least in part on the training input data; and configuring the one or more machine learning models based at least in part on a comparison between the output data and the set of training labels.

Clause 5: The method of any one of Clauses 1-4, wherein the first plurality of parameters includes one or more of: a first set of operating parameters associated with the at least one network node; a second set of operating parameters associated with the at least one UE; a first set of performance metrics associated with the at least one network node; or a second set of performance metrics associated with the at least one UE.

Clause 6: The method of any one of Clauses 1-5, wherein: the first training data set forms a graph data structure associated with the scenario; the plurality of first parameters includes a first set of parameters associated with one or more vertices in the graph data structure and a second set of parameters associated with one or more links in the graph data structure; the one or more vertices includes the at least one network node and the at least one UE; and the one or more links includes a serving link between the at least one network node and the at least one UE.

Clause 7: The method of any one of Clauses 1-6, wherein the one or more machine learning models comprises one or more graph neural networks.

Clause 8: The method of Clause 7, wherein the one or more graph neural networks comprise a first neural network associated with the at least one network node and a second neural network associated with the at least one UE.

Clause 9: The method of any one of Clauses 1-8, wherein the first network simulator comprises a Monte Carlo-based network simulator.

Clause 10: The method of any one of Clauses 1-9, wherein: the first training data set is derived from the first network simulator; the second training data set is derived from the second network simulator; and generating the third training data set comprises generating the third training data set based at least in part on a comparison between the first training data set and the second training data set.

Clause 11: The method of Clause 10, wherein the comparison comprises a comparison of statistical values among the first training data set and the second training data set.

Clause 12: The method of Clause 10, wherein obtaining the first training data set comprises: obtaining an indication of first information associated with generation of the second training data set, wherein the first information includes at least one configuration of the second plurality of configurations; and configuring the first network simulator to apply the first plurality of configurations, including the at least one configuration, in association with simulation of the wireless communication network.

Clause 13: The method of Clause 12, wherein the first information includes one or more of: one or more outer loop adaptation parameters; channel state feedback communicated between the at least one UE and the at least one network node; one or more link curves associated with signaling decoding; or one or more path losses associated with a communication link between the at least one UE and the at least one network node.

Clause 14: The method of Clause 12, wherein obtaining the second training data set comprises: sending an indication of second information associated with generation of the first training data set; and obtaining the second training data set after communication of the indication of the second information.

Clause 15: The method of Clause 14, wherein the first information comprises one or more of: an indication of signaling communicated between the at least one UE and the at least one network node; an indication of one or more wireless communication channels between the at least one UE and the at least one network node; an indication of one or more subcarriers associated with multi-carrier communications between the at least one UE and the at least one network node; or an indication of baseband signaling communicated between the at least one UE and the at least one network node.

Clause 16: The method of any one of Clauses 1-15, wherein training the one or more machine learning models comprises: training a first set of machine learning models of the one or more machine learning models based at least in part on the third training data set; or training a second set of machine learning models of the one or more machine learning models based at least in part on a fourth training data set derived from the first training data set and the second training data set.

Clause 17: The method of any one of Clauses 1-16, wherein: the one or more machine learning models comprise a neural network that includes a first set of machine learning models associated with the at least one network node and a second set of machine learning models associated with the at least one UE; and training the one or more machine learning models comprises: communicating one or more of: (i) forward pass information associated with one or more of the first set of machine learn models or the second set of machine learning models, or (ii) backpropagation information associated with one or more of the first set of machine learning models and the second set of machine learning models; and training the one or more machine learning models further based at least in part on one or more of the forward pass information or the backpropagation information.

Clause 18: The method of Clause 10, wherein: the one or more machine learning models comprise a neural network that includes a first set of machine learning models associated with the at least one network node and a second set of machine learning models associated with the at least one UE; and training the one or more machine learning models comprises: training the first set of machine learning models of the neural network based at least in part on the third training data set; and training the second set of machine learning models of the neural network, comprising the trained first set of machine learning models, based at least in part on a fourth training data set derived from the first training data set and the second training data set.

Clause 19: The method of Clause 10, wherein: the one or more machine learning models comprise a neural network that includes a first set of machine learning models associated with the at least one network node and a second set of machine learning models associated with the at least one UE; and training the one or more machine learning models comprises: training the first set of machine learning models of the neural network based at least in part on the third training data set; and training the second set of machine learning models and the first set of machine learning models based at least in part on a fourth training data set derived from the first training data set and the second training data set.

Clause 20: The method of any one of Clauses 1-19, further comprising: providing, to the one or more machine learning models, input data; and obtaining, from the one or more machine learning models, output data that indicates the one or more performance metrics associated with the wireless communication network.

Clause 21: One or more apparatuses, comprising: one or more memories comprising executable instructions; and one or more processors configured to execute the executable instructions and cause the one or more apparatuses to perform a method in accordance with any one of Clauses 1-20.

Clause 22: One or more apparatuses configured for wireless communications, comprising: one or more memories; and one or more processors, coupled to the one or more memories, configured to cause the one or more apparatuses to perform a method in accordance with any one of Clauses 1-20.

Clause 23: One or more apparatuses configured for wireless communications, comprising: one or more memories; and one or more processors, coupled to the one or more memories, configured to perform a method in accordance with any one of Clauses 1-20.

Clause 24: One or more apparatuses, comprising means for performing a method in accordance with any one of Clauses 1-20.

Clause 25: One or more non-transitory computer-readable media comprising executable instructions that, when executed by one or more processors of one or more apparatuses, cause the one or more apparatuses to perform a method in accordance with any one of Clauses 1-20.

Clause 26: One or more computer program products embodied on one or more computer-readable storage media comprising code for performing a method in accordance with any one of Clauses 1-20.

Clause 27: One or more apparatuses configured for wireless communications, comprising: a processing system that includes one or more processors and one or more memories coupled with the one or more processors, the processing system configured to cause the one or more apparatuses to perform a method in accordance with any one of Clauses 1-20.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus, comprising a processing system that includes one or more processors and one or more memories coupled with the one or more processors, the processing system configured to cause the apparatus to:
obtain a first training data set associated with a first network simulator, wherein the first training data set includes a first plurality of parameters associated with simulation of a wireless communication network operating, in a scenario, according to a first plurality of configurations, wherein the wireless communication network includes at least one network node in communication with at least one user equipment (UE);
obtain a second training data set associated with a second network simulator, wherein the second training data set includes a second plurality of parameters associated with simulation of the wireless communication network operating, in the scenario, according to a second plurality of configurations;
generate a third training data set based at least in part on the first training data set and the second training data set; and
train one or more machine learning models, associated with prediction of one or more performance metrics of the wireless communication network, based at least in part on the third training data set.

2. The apparatus of claim 1, wherein the scenario defines one or more properties associated with the wireless communication network, wherein the one or more properties are commonly applied among the first network simulator and the second network simulator.

3. The apparatus of claim 1, wherein to cause the apparatus to obtain the first training data set, the processing system is configured to cause the apparatus to:
configure the first network simulator to output a set of performance metrics associated with simulation of the wireless communication network operating, in the scenario, according to the first plurality of configurations;
obtain the set of performance metrics from the configured first network simulator; and
generate the first training data set based at least in part on the set of performance metrics and the first plurality of configurations.

4. The apparatus of claim 1, wherein to cause the apparatus to train the one or more machine learning models, the processing system is configured to cause the apparatus to:
provide, to the one or more machine learning models, training input data, wherein the third training data set comprises the training input data and a set of training labels associated with the training input data;
obtain, from the one or more machine learning models, output data based at least in part on the training input data; and
configure the one or more machine learning models based at least in part on a comparison between the output data and the set of training labels.

5. The apparatus of claim 1, wherein the first plurality of parameters includes one or more of:
a first set of operating parameters associated with the at least one network node;
a second set of operating parameters associated with the at least one UE;
a first set of performance metrics associated with the at least one network node; or
a second set of performance metrics associated with the at least one UE.

6. The apparatus of claim 1, wherein:
the first training data set forms a graph data structure associated with the scenario;
the plurality of first parameters includes a first set of parameters associated with one or more vertices in the graph data structure and a second set of parameters associated with one or more links in the graph data structure;
the one or more vertices includes the at least one network node and the at least one UE; and
the one or more links includes a serving link between the at least one network node and the at least one UE.

7. The apparatus of claim 1, wherein the one or more machine learning models comprises one or more graph neural networks.

8. The apparatus of claim 1, wherein the first network simulator comprises a Monte Carlo-based network simulator.

9. The apparatus of claim 1, wherein:
the first training data set is derived from the first network simulator;
the second training data set is derived from the second network simulator; and
to cause the apparatus to generate the third training data set, the processing system is configured to cause the apparatus to generate the third training data set based at least in part on a comparison between the first training data set and the second training data set.

10. The apparatus of claim 9, wherein to cause the apparatus to obtain the first training data set, the processing system is configured to cause the apparatus to:
obtain an indication of first information associated with generation of the second training data set, wherein the first information includes at least one configuration of the second plurality of configurations; and
configure the first network simulator to apply the first plurality of configurations, including the at least one configuration, in association with simulation of the wireless communication network.

11. The apparatus of claim 10, wherein the first information includes one or more of:
one or more outer loop adaptation parameters;
channel state feedback communicated between the at least one UE and the at least one network node;
one or more link curves associated with signaling decoding; or
one or more path losses associated with a communication link between the at least one UE and the at least one network node.

12. The apparatus of claim 10, wherein to cause the apparatus to obtain the second training data set, the processing system is configured to cause the apparatus to:
send an indication of second information associated with generation of the first training data set; and
obtain the second training data set after communication of the indication of the second information.

13. The apparatus of claim 12, wherein the first information comprises one or more of:
an indication of signaling communicated between the at least one UE and the at least one network node;
an indication of one or more wireless communication channels between the at least one UE and the at least one network node;
an indication of one or more subcarriers associated with multi-carrier communications between the at least one UE and the at least one network node; or
an indication of baseband signaling communicated between the at least one UE and the at least one network node.

14. The apparatus of claim 1, wherein to cause the apparatus to train the one or more machine learning models, the processing system is configured to cause the apparatus to one or more of:
train a first set of machine learning models of the one or more machine learning models based at least in part on the third training data set; or
train a second set of machine learning models of the one or more machine learning models based at least in part on a fourth training data set derived from the first training data set and the second training data set.

15. The apparatus of claim 1, wherein:
the one or more machine learning models comprise a neural network that includes a first set of machine learning models associated with the at least one network node and a second set of machine learning models associated with the at least one UE; and
to cause the apparatus to train the one or more machine learning models, the processing system is configured to cause the apparatus to:
communicate one or more of:
(i) forward pass information associated with one or more of the first set of machine learn models or the second set of machine learning models, or
(ii) backpropagation information associated with one or more of the first set of machine learning models and the second set of machine learning models; and
train the one or more machine learning models further based at least in part on one or more of the forward pass information or the backpropagation information.

16. The apparatus of claim 9, wherein:
the one or more machine learning models comprise a neural network that includes a first set of machine learning models associated with the at least one network node and a second set of machine learning models associated with the at least one UE; and
to cause the apparatus to train the one or more machine learning models, the processing system is configured to cause the apparatus to:
train the first set of machine learning models of the neural network based at least in part on the third training data set; and
train the second set of machine learning models of the neural network, comprising the trained first set of machine learning models, based at least in part on a fourth training data set derived from the first training data set and the second training data set.

17. The apparatus of claim 9, wherein:
the one or more machine learning models comprise a neural network that includes a first set of machine learning models associated with the at least one network node and a second set of machine learning models associated with the at least one UE; and
to cause the apparatus to train the one or more machine learning models, the processing system is configured to cause the apparatus to:
train the first set of machine learning models of the neural network based at least in part on the third training data set; and
train the second set of machine learning models and the first set of machine learning models based at least in part on a fourth training data set derived from the first training data set and the second training data set.

18. The apparatus of claim 1, wherein the processing system is configured to cause the apparatus to:
provide, to the one or more machine learning models, input data; and
obtain, from the one or more machine learning models, output data that indicates the one or more performance metrics associated with the wireless communication network.

19. A method, comprising:
obtaining a first training data set associated with a first network simulator, wherein the first training data set includes a first plurality of parameters associated with simulation of a wireless communication network operating, in a scenario, according to a first plurality of configurations, wherein the wireless communication network includes at least one network node in communication with at least one user equipment (UE);
obtaining a second training data set associated with a second network simulator, wherein the second training data set includes a second plurality of parameters associated with simulation of the wireless communication network operating, in the scenario, according to a second plurality of configurations;
generating a third training data set based at least in part on the first training data set and the second training data set; and
training one or more machine learning models, associated with prediction of one or more performance metrics of the wireless communication network, based at least in part on the third training data set.

20. A non-transitory computer-readable medium comprising executable instructions that, when executed by one or more processors of one or more apparatuses, cause the one or more apparatuses to:
obtain a first training data set associated with a first network simulator, wherein the first training data set includes a first plurality of parameters associated with simulation of a wireless communication network operating, in a scenario, according to a first plurality of configurations, wherein the wireless communication network includes at least one network node in communication with at least one user equipment (UE);
obtain a second training data set associated with a second network simulator, wherein the second training data set includes a second plurality of parameters associated with simulation of the wireless communication network operating, in the scenario, according to a second plurality of configurations;
generate a third training data set based at least in part on the first training data set and the second training data set; and
train one or more machine learning models, associated with prediction of one or more performance metrics of the wireless communication network, based at least in part on the third training data set.
